(19) United States
(12) Patent Application Publication
(10) Pub. No.: US 2024/0286202 A1
(43) Pub. Date: Aug. 29, 2024

(54) Retainer for a Rotating Bit

(71) Applicant: The Sollami Company, Herrin, IL (US)

(72) Inventor: Phillip Sollami, Herrin, IL (US)

(73) Assignee: The Sollami Company, Herrin, IL (US)

(21) Appl. No.: 18/236,672

(22) Filed: Aug. 22, 2023

Related U.S. Application Data
(63) Continuation-in-part of application No. 18/059,682, filed on Nov. 29, 2022.
(63) Continuation-in-part of application No. 18/102,311, filed on Jan. 27, 2023.
(63) Continuation-in-part of application No. 18/134,659, filed on Apr. 14, 2023.
(60) Provisional application No. 63/466,041, filed on May 12, 2023.

(51) Int. Cl. B23B 31/117

(52) U.S. Cl. CPC B23B 31/117

(57) ABSTRACT

A retainer for a rotating bit and/or pick that includes a slot extending from a forward end of the retainer to a distal end of the retainer. The slot includes a gap profile formed by the configuration or design of a first radial end surface of the slot and a second radial end surface of the slot. The retainer includes at least one lead-in chamfer at the distal end of the retainer comprising a chamfer length that is greater than a chamfer height. The retainer can also include at least one compression slot extending from the distal end of the retainer and/or at least one radially and axially oriented axial locator tab adapted to engage a shank of a rotating bit.

### CROSS-REFERENCE TO RELATED APPLICATION(S)

This application claims priority to U.S. Provisional Application No. 63/466,041, filed May 12, 2023, claims priority to and is a continuation-in-part of U.S. Non-provisional application Ser. No. 17/970,325, filed Oct. 20, 2022, claims priority to and is a continuation-in-part of U.S. Non-provisional application Ser. No. 18/059,662, filed Nov. 29, 2022, claims priority to and is a continuation-in-part of U.S. Non-provisional application Ser. No. 18/102,311, filed Jan. 27, 2023, and claims priority to and is a continuation-in-part of U.S. Non-provisional application Ser. No. 18/134,659, filed Apr. 14, 2023, to the extent allowed by law and the contents of which are incorporated herein by reference in their entireties. The contents of Applicant's U.S. Non-Provisional application Ser. No. 17/877,084, filed Jul. 29, 2022, Applicant's U.S. Non-Provisional application Ser. No. 17/146,992, filed Jan. 12, 2021, Applicant's U.S. Provisional Application No. 62/898,654, filed Sep. 11, 2019, Applicant's U.S. Provisional Application No. 62/965,237, filed Jan. 24, 2020, Applicant's U.S. Pat. No. 10,107,098, issued Oct. 23, 2018, and Applicant's U.S. Pat. No. 10,612,376, issued Apr. 7, 2020, are incorporated herein by reference in their entireties

### TECHNICAL FIELD

This disclosure relates to a bit and/or pick for road milling, mining, and trenching equipment, and more particularly, to a retainer for a rotating bit.

### BACKGROUND

Road milling, mining, and trenching equipment utilizes bits and/or picks traditionally set in a bit assembly. Bit assemblies can include a bit and/or pick retained within a bore in a base block. Bit assemblies can also include a bit and/or pick retained by a bit holder and the bit holder retained within a bore in a base block. A plurality of the bit assemblies are mounted on the outside of a rotatable drum, typically in a V-shaped or spiral configuration. A plurality of the bit assemblies can also be mounted on an endless chain and plate configurations. The combinations of bit assemblies have been utilized to remove material from the terra firma, such as degrading the surface of the earth, minerals, cement, concrete, macadam or asphalt pavement. Individual bits and/or picks, bit holders, and base blocks may wear down or break over time due to the harsh road degrading environment. Additionally, the forces and vibrations exerted on the bit assemblies may cause the bit and/or pick to wear away the bore in the base block, the bit and/or pick to wear away the bore in the bit holder, or the bit holder to wear away the bore in the base block. For rotating bits, a slotted retainer, sleeve, and washer disposed circumferentially around the bit shank, for example, are used to maintain the bit in the bit bolder. The separate washer will generally attach itself to the rear annular flange of the bit body in a non-parallel or askew fit while in use, which prevents the bit body from freely rotating thereby substantially reducing the bit life. Over time, a gap forms between a bottom of the bit body and a forward face of the bit holder, allowing dirt, debris, and fines to enter the space between the outer diameter of the bit shank and the inner diameter of the retainer, resulting in poorer rotation of the bit, reducing the life of a carbide tip of the bit and increasing the bit holder face wear, such as an flat annular face at a forward end of the bit holder, and bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a slotted retainer with varying features adjacent a distal end of the retainer will not only ease the insertion of the bit into the bit holder, reduce costs, and reduce axial movement. The slotted retainer of the present disclosure also forms nearly 100 percent sealed areas between the inner diameter of the retainer and the outer diameter or the shank, between the bottom of the bit body planar surface adjacent the tire and bit shank and the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block.

### SUMMARY

This disclosure relates generally to bit and/or pick assemblies for road milling, mining, and trenching equipment. One implementation of the teachings herein is a retainer that includes a generally cylindrical hollow body portion including an axial forward end and an axial distal end; a first slot extending through a sidewall of the body portion from the axial forward end to the axial distal end; and at least one chamfer at the axial distal end of the retainer extending to an outer surface of the retainer, the at least one chamfer comprising a chamfer length and a chamfer height, the chamfer length being greater than the chamfer height.

In another implementation of the teachings herein is a bit that includes a body portion; a generally cylindrical shank axially depending from a bottom of the body portion; and a retainer disposed circumferentially about the shank, the retainer including a generally cylindrical hollow body portion including an axial forward end and an axial distal end; a first slot extending through a sidewall of the body portion from the axial forward end to the axial distal end; and at least one chamfer at the axial distal end of the retainer extending to an outer surface of the retainer, the at least one chamfer comprising a chamfer length and a chamfer height, the chamfer length being greater than the chamfer height.

These and other aspects of the present disclosure are disclosed in the following detailed description of the embodiments, the appended claims and the accompanying figures.

### BRIEF DESCRIPTION OF THE DRAWINGS

The various features, advantages, and other uses of the apparatus will become more apparent by referring to the following detailed description and drawings, wherein like reference numerals refer to like parts throughout the several views. It is emphasized that, according to common practice, the various features of the drawings are not to-scale. On the contrary, the dimensions of the various features are arbitrarily expanded or reduced for clarity.

FIG. 1 is a top perspective view of a first illustrated embodiment of a retainer, showing a slot including a linear gap profile, a plurality of lead-in chamfers at a distal end of the retainer, a compression slot extending from the distal end of the retainer, and a plurality of tabs adjacent the distal end of the retainer, in accordance with implementations of this disclosure:

FIG. 2 is a top elevation view of the first illustrated embodiment of the retainer, showing the slot including the linear gap profile, the plurality of lead-in chamfers, the compression slot, in accordance with implementations of this disclosure;

FIG. 3 is a top perspective view of the first illustrated embodiment of the retainer, showing the slot, the plurality of lead-in chamfers, the compression slot, and the plurality of tabs, in accordance with implementations of this disclosure;

FIG. 4 is a left side elevation view of the first illustrated embodiment of the retainer, showing one lead-in chamfer and one tab, in accordance with implementations of this disclosure;

FIG. 5 is a distal end elevation view of the first illustrated embodiment of the retainer, showing the slot, the plurality of lead-in chamfers, the compression slot, and the plurality of tabs, in accordance with implementations of this disclosure;

FIG. 6 is a right side elevation view of the first illustrated embodiment of the retainer. showing one lead-in chamfer and one tab, in accordance with implementations of this disclosure;

FIG. 7 is a bottom perspective view of the first illustrated embodiment of the retainer, showing the slot, the plurality of lead-in chamfers, the compression slot, and the plurality of tabs, in accordance with implementations of this disclosure;

FIG. 8 is a bottom elevation view of the first illustrated embodiment of the retainer, showing the plurality of lead-in chamfers and the compression slot, in accordance with implementations of this disclosure;

FIG. 9 is a bottom perspective view of the first illustrated embodiment of the retainer, showing the slot, the plurality of lead-in chamfers, the compression slot, and the plurality of tabs. in accordance with implementations of this disclosure;

FIG. 10 is a top perspective view of a second illustrated embodiment of a retainer, showing a slot including a linear gap profile, a plurality of lead-in chamfers at a distal end of the retainer, a first compression slot extending from the distal end of the retainer opposite the slot, a plurality of second compression slots extending from the distal end of the retainer, and a plurality of tabs adjacent the distal end of the retainer, in accordance with implementations of this disclosure;

FIG. 11 is a top elevation view of the second illustrated embodiment of the retainer, showing the slot including the linear gap profile, the plurality of lead-in chamfers, and the first compression slot, in accordance with implementations of this disclosure;

FIG. 12 is a top perspective view of the second illustrated embodiment of the retainer, showing the slot, the plurality of lead-in chamfers, the first compression slot, the plurality of second compression slots, and the plurality of tabs, in accordance with implementations of this disclosure;

FIG. 13 is a left side elevation view of the second illustrated embodiment of the retainer, showing the plurality of lead-in chamfers, one second compression slot, and one tab, in accordance with implementations of this disclosure;

FIG. 14 is a distal end elevation view of the second illustrated embodiment of the retainer, showing the slot, the plurality of lead-in chamfers, the first compression slot, the plurality of second compression slots, and the plurality of tabs, in accordance with implementations of this disclosure;

FIG. 15 is a right side elevation view of the second illustrated embodiment of the retainer, showing the plurality of lead-in chamfers, one second compression slot, and one tab, in accordance with implementations of this disclosure;

FIG. 16 is a bottom perspective view of the second illustrated embodiment of the retainer, showing the slot, the plurality of lead-in chamfers, the first compression slot, the plurality of second compression slots, and the plurality of tabs, in accordance with implementations of this disclosure;

FIG. 17 is a bottom elevation view of the second illustrated embodiment of the retainer, showing the plurality of lead-in chamfers and the first compression slot, in accordance with implementations of this disclosure;

FIG. 18 is a bottom perspective view of the second illustrated embodiment of the retainer, showing the slot, the plurality of lead-in chamfers, the first compression slot, the plurality of second compression slots, and the plurality of tabs, in accordance with implementations of this disclosure;

FIG. 19 is top perspective view of a third illustrated embodiment of a retainer, showing a slot including a linear gap profile, a lead-in chamfer at a distal end of the retainer, and a plurality of tabs adjacent the distal end of the retainer, in accordance with implementations of this disclosure;

FIG. 19A is a side elevation view of the third illustrated embodiment of the retainer, showing an inner diameter of the retainer and showing invisible internal elements in dotted lines, in accordance with implementations of this disclosure;

FIG. 19B is a cross-sectional view of the third illustrated embodiment of the retainer taken along Line A-A of FIG. 19A, showing the internal diameter of the retainer, in accordance with implementations of this disclosure;

FIG. 19C is a detail cross-sectional view of Detail B of the third illustrated embodiment of the retainer of FIG. 19B in accordance with implementations of this disclosure;

FIG. 20 is a top elevation view of the third illustrated embodiment of the retainer, showing the slot including the linear gap profile and the lead-in chamfer, in accordance with implementations of this disclosure;

FIG. 21 is top perspective view of the third illustrated embodiment of the retainer, showing the slot, the lead-in chamfer, and the plurality of tabs, in accordance with implementations of this disclosure;

FIG. 22 is left side elevation view of the third illustrated embodiment of the retainer, showing the lead-in chamfer and one tab, in accordance with implementations of this disclosure;

FIG. 23 is a distal end elevation view of the third illustrated embodiment of the retainer, showing the slot, the lead-in chamfer, and the plurality of tabs, in accordance with implementations of this disclosure;

FIG. 24 is a right side elevation view of the third illustrated embodiment of the retainer, showing the lead-in chamfer and one tab, in accordance with implementations of this disclosure;

FIG. 25 is a bottom perspective view of the third illustrated embodiment of the retainer, showing the slot, the lead-in chamfer, and one tab, in accordance with implementations of this disclosure;

FIG. 26 is a bottom elevation view of the third illustrated embodiment of the retainer, showing the lead-in chamfer, in accordance with implementations of this disclosure;

FIG. 27 is a bottom perspective view of the third illustrated embodiment of the retainer, showing the slot, the lead-in chamfer, and one tab, in accordance with implementations of this disclosure;

FIG. 28 is a top perspective view of a fourth illustrated embodiment of a retainer, showing a slot including a linear gap profile, a plurality of lead-in chamfers at a distal end of the retainer, a plurality of compression extending from the distal end of the retainer, and a plurality of tabs adjacent the distal end of the retainer, in accordance with implementations of this disclosure;

FIG. 29 is a top elevation view of the fourth illustrated embodiment of the retainer. showing the slot including the linear gap profile, the plurality of lead-in chamfers, and the plurality of compression slots, in accordance with implementations of this disclosure;

FIG. 30 is a top perspective view of the fourth illustrated embodiment of the retainer, showing the slot, the plurality of lead-in chamfers, the plurality of compression slots, and the plurality of tabs, in accordance with implementations of this disclosure;

FIG. 31 is a left side elevation view of the fourth illustrated embodiment of the retainer, showing the plurality of lead-in chamfers, the plurality of compression slots, and one tab, in accordance with implementations of this disclosure;

FIG. 32 is a distal end elevation view of the fourth illustrated embodiment of the retainer, showing the slot, the plurality of lead-in chamfers, the plurality of compression slots, and the plurality of tabs, in accordance with implementations of this disclosure;

FIG. 33 is a right side elevation view of the fourth illustrated embodiment of the retainer, showing the plurality of lead-in chamfers, the plurality of compression slots, and one tab, in accordance with implementations of this disclosure;

FIG. 34 is a bottom perspective view of the fourth illustrated embodiment of the retainer, showing the slot, the plurality of lead-in chamfers, the plurality of compression slots, and one tab, in accordance with implementations of this disclosure;

FIG. 35 is a bottom elevation view of the fourth illustrated embodiment of the retainer, showing the plurality of lead-in chamfers and the plurality of compression slots, in accordance with implementations of this disclosure;

FIG. 36 is a bottom perspective view of the fourth illustrated embodiment of the retainer, showing the slot, the plurality of lead-in chamfers, the plurality of compression slots, and one tab, in accordance with implementations of this disclosure;

FIG. 37 is a top perspective view of a fifth illustrated embodiment of a retainer, showing a slot including a linear gap profile, a plurality of lead-in chamfers at a distal end of the retainer, a dual corner break at the distal end of the retainer, a relief notch at the distal end of the retainer, compression slot extending from a distal end of the relief notch, and a plurality of tabs adjacent the distal end of the retainer, in accordance with implementations of this disclosure;

FIG. 38 is a top elevation view of the fifth illustrated embodiment of the retainer, showing the slot including the linear gap profile, the plurality of lead-in chamfers, dual corner break, the relief notch, and the compression slot, in accordance with implementations of this disclosure:

FIG. 39 is a top perspective view of the fifth illustrated embodiment of the retainer, showing the slot, the plurality of lead-in chamfers, the dual corner break, the relief notch, and the plurality of tabs, in accordance with implementations of this disclosure;

FIG. 40 is a bottom perspective view of the fifth illustrated embodiment of the retainer, showing the slot, the plurality of lead-in chamfers, the dual corner break, the relief notch, the compression slot, and the plurality of tabs, in accordance with implementations of this disclosure;

FIG. 41 is a bottom elevation view of the fifth illustrated embodiment of the retainer, showing the plurality of lead-in chamfers, the relief notch, and the compression slot, in accordance with implementations of this disclosure:

FIG. 42 is a bottom perspective view of the fifth illustrated embodiment of the retainer, showing the slot, the plurality of lead-in chamfers, the dual corner break, the relief notch, the compression slot, and the plurality of tabs, in accordance with implementations of this disclosure;

FIG. 43 is a left side elevation view of the fifth illustrated embodiment of the retainer, showing one lead-in chamfer and one tab, in accordance with implementations of this disclosure;

FIG. 44 is a distal end elevation view of the fifth illustrated embodiment of the retainer, showing the slot, the plurality of lead-in chamfers, the dual corner break, the relief notch, the compression slot, and the plurality of tabs, in accordance with implementations of this disclosure;

FIG. 45 is a right side elevation view of the fifth illustrated embodiment of the retainer, showing one lead-in chamfer and one tab, in accordance with implementations of this disclosure;

FIG. 46 is a detail view of Detail C of the fifth illustrated embodiment of the retainer of FIG. 38, showing a height of one lead-in chamfer and a length of one lead-in chamfer, in accordance with implementations of this disclosure;

FIG. 47 is a side elevation view of the fifth illustrated embodiment of the retainer. showing an inner diameter of the retainer and showing invisible internal elements in dotted lines, in accordance with implementations of this disclosure;

FIG. 48 is a cross-sectional view of the fifth illustrated embodiment of the retainer taken along Line D-D of FIG. 47, showing the internal diameter of the retainer, in accordance with implementations of this disclosure;

FIG. 49 is a detail cross-sectional view of Detail E of the fifth illustrated embodiment of the retainer of FIG. 48 in accordance with implementations of this disclosure;

FIG. 50 is a bottom side elevation view of a first illustrated embodiment of a bit, including the first illustrated embodiment of the retainer disposed circumferentially around a shank of the bit, in accordance

FIG. 51 is a distal end elevation view of the first illustrated embodiment of the bit, including the first illustrated embodiment of the retainer, in accordance with implementations of this disclosure;

FIG. 52 is a bottom side elevation view of the first illustrated embodiment of the bit, including the first illustrated embodiment of the retainer assembled circumferentially around the shank of the bit, in accordance with implementations of this disclosure;

FIG. 53 is a bottom perspective view of the first illustrated embodiment of the bit, including the first illustrated embodiment of the retainer assembled circumferentially around the shank of the bit, in accordance with implementations of this disclosure;

FIG. 54 is a side elevation view of the first illustrated embodiment of the bit, including the first illustrated embodiment of the retainer assembled circumferentially around the shank of the bit, in accordance with implementations of this disclosure;

FIG. 55 is a top perspective view of the first illustrated embodiment of the bit, including the first illustrated embodiment of the retainer assembled circumferentially around the shank of the bit, in accordance with implementations of this disclosure;

FIG. 56 is a bottom side elevation view of the first illustrated embodiment of the bit, including the second illustrated embodiment of the retainer assembled circumferentially around a shank of the bit, in accordance with implementations of this disclosure;

FIG. 57 is a distal end elevation view of the first illustrated embodiment of the bit, including the second illustrated embodiment of the retainer assembled circumferentially around the shank of the bit, in accordance with implementations of this disclosure;

FIG. 58 is a top elevation view of the first illustrated embodiment of the bit, including the second illustrated embodiment of the retainer assembled circumferentially around the shank of the bit, in accordance with implementations of this disclosure;

FIG. 59 is a bottom perspective view of the first illustrated embodiment of the bit, including the second illustrated embodiment of the retainer assembled circumferentially around the shank of the bit, in accordance with implementations of this disclosure;

FIG. 60 is a side elevation view of the first illustrated embodiment of the bit, including the second illustrated embodiment of the retainer assembled circumferentially around the shank of the bit, in accordance with implementations of this disclosure;

FIG. 61 is a top perspective view of the first illustrated embodiment of the bit, including the second illustrated embodiment of the retainer assembled circumferentially around the shank of the bit, in accordance with implementations of this disclosure;

FIG. 62 is a bottom elevation view of the first illustrated embodiment of the bit, including the third illustrated embodiment of the retainer assembled circumferentially around the shank of the bit, in accordance with implementations of this disclosure;

FIG. 63 is a distal end elevation view of the first illustrated embodiment of the bit. including the third illustrated embodiment of the retainer assembled circumferentially around the shank of the bit, in accordance with implementations of this disclosure;

FIG. 64 is a top elevation view of the first illustrated embodiment of the bit, including the third illustrated embodiment of the retainer assembled around the shank of the bit, in accordance with implementations of this disclosure;

FIG. 65 is a bottom perspective view of the first illustrated embodiment of the bit, including the third illustrated embodiment of the retainer assembled circumferentially around the shank of the bit, in accordance with implementations of this disclosure;

FIG. 66 is a side elevation view of the first illustrated embodiment of the bit, including the third illustrated embodiment of the retainer assembled circumferentially around the shank of the bit, in accordance with implementations of this disclosure;

FIG. 67 is a top perspective view of the first illustrated embodiment of the bit, including the third illustrated embodiment of the retainer assembled circumferentially around the shank of the bit, in accordance with implementations of this disclosure;

FIG. 68 is a bottom elevation view of the first illustrated embodiment of the bit, including the fourth illustrated embodiment of the retainer assembled circumferentially around the shank of the bit, in accordance with implementations of this disclosure;

FIG. 69 is a distal end elevation view of the first illustrated embodiment of the bit, including the fourth illustrated embodiment of the retainer assembled circumferentially around the shank of the bit, in accordance with implementations of this disclosure;

FIG. 70 is a top elevation view of the first illustrated embodiment of the bit, including the fourth illustrated embodiment of the retainer assembled circumferentially around the shank of the bit, in accordance with implementations of this disclosure;

FIG. 71 is a bottom perspective view of the first illustrated embodiment of the bit, including the fourth illustrated embodiment of the retainer assembled circumferentially around the shank of the bit, in accordance with implementations of this disclosure;

FIG. 72 is a side elevation view of the first illustrated embodiment of the bit, including the fourth illustrated embodiment of the retainer assembled circumferentially around the shank of the bit, in accordance with implementations of this disclosure;

FIG. 73 is a top perspective view of the first illustrated embodiment of the bit, including the fourth illustrated embodiment of the retainer assembled circumferentially around the shank of the bit, in accordance with implementations of this disclosure;

FIG. 74 is an exploded side elevation view of a first illustrated embodiment of a bit assembly, showing a base block, a bit holder, the first illustrated embodiment of the retainer, and the first illustrated embodiment of the bit, in accordance with implementations of this disclosure;

FIG. 75 is an exploded side elevation view of the first illustrated embodiment of the bit assembly, shown with the bit holder assembled into a bore of the base block and with the first illustrated embodiment of the retainer assembled circumferentially around the shank of the bit, in accordance with implementations of this disclosure;

FIG. 76 is a distal end elevation view of the first illustrated embodiment of the bit assembly, shown with the first illustrated embodiment of the retainer assembled circumferentially around the shank of the bit, the shank of the bit assembled into a bore of the bit holder, and the bit holder assembled into the bore of the base block, in accordance with implementations of this disclosure;

FIG. 77 is a cross-sectional view of the first illustrated embodiment of the bit assembly taken along Line F-F of FIG. 76, in accordance with implementations of this disclosure;

FIG. 78 is an exploded side elevation view of a second illustrated embodiment of a bit assembly, showing the base block, the bit holder, the second illustrated embodiment of the retainer, and the first illustrated embodiment of the bit, in accordance with implementations of this disclosure;

FIG. 79 is an exploded side elevation view of the second illustrated embodiment of the bit assembly, shown with the bit holder assembled into the bore of the base block and with the second illustrated embodiment of the retainer assembled circumferentially around the shank of the bit, in accordance with implementations of this disclosure;

FIG. 80 is a distal end elevation view of the second illustrated embodiment of the bit assembly, shown with the second illustrated embodiment of the retainer assembled circumferentially around the shank of the bit, the shank of the bit assembled into the bore of the bit holder, and the bit holder assembled into the bore of the base block, in accordance with implementations of this disclosure;

FIG. 81 is a cross-sectional view of the second illustrated embodiment of the bit assembly taken along Line G-G of FIG. 80, in accordance with implementations of this disclosure;

FIG. 82 is an exploded side elevation view of a third illustrated embodiment of a bit assembly, showing the base block, the bit holder, the third illustrated embodiment of the retainer, and the first illustrated embodiment of the bit, in accordance with implementations of this disclosure;

FIG. 83 is an exploded side elevation view of the third illustrated embodiment of the bit assembly, shown with the bit holder assembled into the bore of the base block and with the third illustrated embodiment of the retainer assembled circumferentially around the shank of the bit, in accordance with implementations of this disclosure;

FIG. 84 is a distal end elevation view of the third illustrated embodiment of the bit assembly, shown with the third illustrated embodiment of the retainer assembled circumferentially around the shank of the bit, the shank of the bit assembled into the bore of the bit holder, and the bit holder assembled into the bore of the base block, in accordance with implementations of this disclosure;

FIG. 85 is a cross-sectional view of the third illustrated embodiment of the bit assembly taken along Line H-H of FIG. 84, in accordance with implementations of this disclosure;

FIG. 86 is an exploded side elevation view of a fourth illustrated embodiment of a bit assembly, showing the base block, the bit holder, the fourth illustrated embodiment of the retainer, and the first illustrated embodiment of the bit, in accordance with implementations of this disclosure;

FIG. 87 is an exploded side elevation view of the fourth illustrated embodiment of the bit assembly, shown with the bit holder assembled into the bore of the base block and with the fourth illustrated embodiment of the retainer assembled circumferentially around the shank of the bit, in accordance with implementations of this disclosure;

FIG. 88 is a distal end elevation view of the fourth illustrated embodiment of the bit assembly, shown with the fourth illustrated embodiment of the retainer assembled circumferentially around the shank of the bit, the shank of the bit assembled into the bore of the bit holder, and the bit holder assembled into the bore of the base block, in accordance with implementations of this disclosure;

FIG. 89 is a cross-sectional view of the fourth illustrated embodiment of the bit assembly taken along Line I-I of FIG. 88, in accordance with implementations of this disclosure;

FIG. 90 is a perspective view of a prior art bit and the first illustrated embodiment of the bit, showing the wear pattern on the prior art bit compared to first illustrated embodiment of the bit, in accordance with implementations of this disclosure;

FIG. 91 is a perspective view of the prior art bit and the first illustrated embodiment of the bit, showing the wear pattern on the prior art bit compared to first illustrated embodiment of the bit, in accordance with implementations of this disclosure;

FIG. 92 is a detail view of the prior art bit showing the wear pattern on the prior art bit; and

FIG. 93 is a detail view of the first illustrated embodiment of the bit showing the wear pattern on the first illustrated embodiment of the bit.

### DETAILED DESCRIPTION

Road milling, mining, and trenching equipment utilizes bits and/or picks traditionally set in a bit assembly. Bit assemblies can include a bit and/or pick retained within a bore in a base block. For rotating bits, a slotted retainer, sleeve, and washer disposed circumferentially around the bit shank, for example, have typically been used to maintain a milling bit in the bit holder. The washer is disposed circumferentially about the bit shank and partially or entirely behind a rear annular flange of the bit body, attempting to avoid any cocking which would prevent the bit from rotating properly. Generally, a drum comprising the milling bits rotates at approximately 90 rpm, which causes the milling bits on the drum to rotate incrementally. Some washers are designed with a counterbore feature that allows a bottom flat surface of the counterbore to be positioned behind the rear annular flange of the bit body and an inner diameter of the counterbore to be positioned over and around a tire diameter of a tire portion of the bit body.

The separate washer will generally attach itself to the rear annular flange of the bit body in a non-parallel or askew fit while in use, which prevents the bit body from freely rotating thereby substantially reducing the bit life. Over time, a gap forms between a bottom of the bit body and a forward face of the bit holder and the washer will begin interfering with bit rotation, developing more clearance between the inner diameter of the retainer and the outer diameter of the bit shank, thereby allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

The separate washer of the prior art bit design generally inhibits rotation due to the multiple interacting components of the bit body, the independent washer, and the retainer. To prolong the life of the bit assembly, and the bit holder and/or the base block, a bit and/or pick comprising a bit body including an integral washer feature and a bit shank including a slotted retainer with varying features adjacent a distal end of the retainer will not only ease the insertion of the bit into the bit holder, reduce costs, and reduce axial movement. The unibody design that incorporates the one-piece washer feature at a distal portion of the bit body significantly improves bit rotation. Superior bit rotation enhances the life of the carbide tip, which also increases the life of the cutter bit. The slotted retainer of the present disclosure also forms nearly 100 percent sealed areas between the inner diameter of the retainer and the outer diameter or the shank, between the bottom of the bit body and the forward end of the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block.

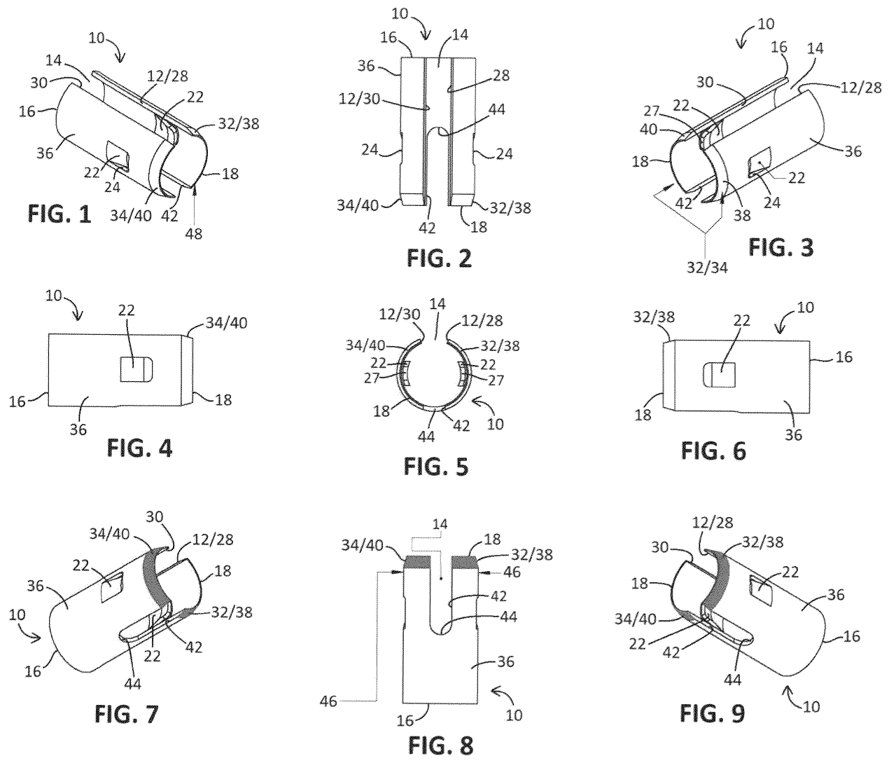

Referring to FIGS. 1-9, a first illustrated embodiment of a retainer 10 is shown in accordance with implementations of this disclosure. Retainer 10 includes a slot 12 axially extending from a forward end 16 of the retainer 10 to a distal end 18 of the retainer 10. The slot 12 comprises a gap profile 14 that is defined by a first radial end surface 28 of the slot 12 and a second radial end surface 30 of the slot 12. In this exemplary illustrated implementation, the radial end surfaces 28, 30 are linear throughout their axial length thereby defining a linear gap profile 14. In alternate embodiments of the retainers described herein, the radial end surfaces 28. 30 and the gap profile 14 may be parallel, serpentine, arcuate, angular, zig-zagged, or any other configuration that can be formed by the radial end surfaces 28, 30 of the slot 12 or combination of same.

The retainer 10 comprises at least one lead-in chamfer. In this exemplary illustrated implementation, the retainer 10 comprises two lead-in chamfers 32, 34 that each comprise a generally 0.002-0.035 inch height and a length that is greater than the height of the chamfers 32, 34, as shown in FIGS. 2, 4, 6, and 8. For explanatory and exemplary purposes only, assuming the retainer 10 is generally 0.050 inch thick, a chamfer 32, 34 including a height of 0.002 inch results in a 0.048 inch retainer thickness at the distal end 18 of the retainer 10 while a chamfer 32, 34 including a height of 0.035 inch results in a 0.015 inch retainer thickness at the distal end 18 of the retainer 10.

In this exemplary illustrated implementation, chamfers 32, 34 extend axially from the distal end 18 of the retainer 10 to an outer surface 36 of the retainer 10 and extend radially and circumferentially around the retainer 10 adjacent the distal end 18 from a compression slot 42 at the distal end 18 of the retainer 10, described below, to the first radial end surface 28 and the second radial end surface 30 of the slot 12, respectively. The lead-in chamfers 32, 34 allow about 50% less distal end 18 contact at a first contact surface 38 and a second contact surface 40, respectively, on the retainer 10 with the inner wall of a bore 272 of a bit holder 250, described below, which is beneficial during the initial insertion of the retainer 10 into the bore 272 of the bit holder 250.

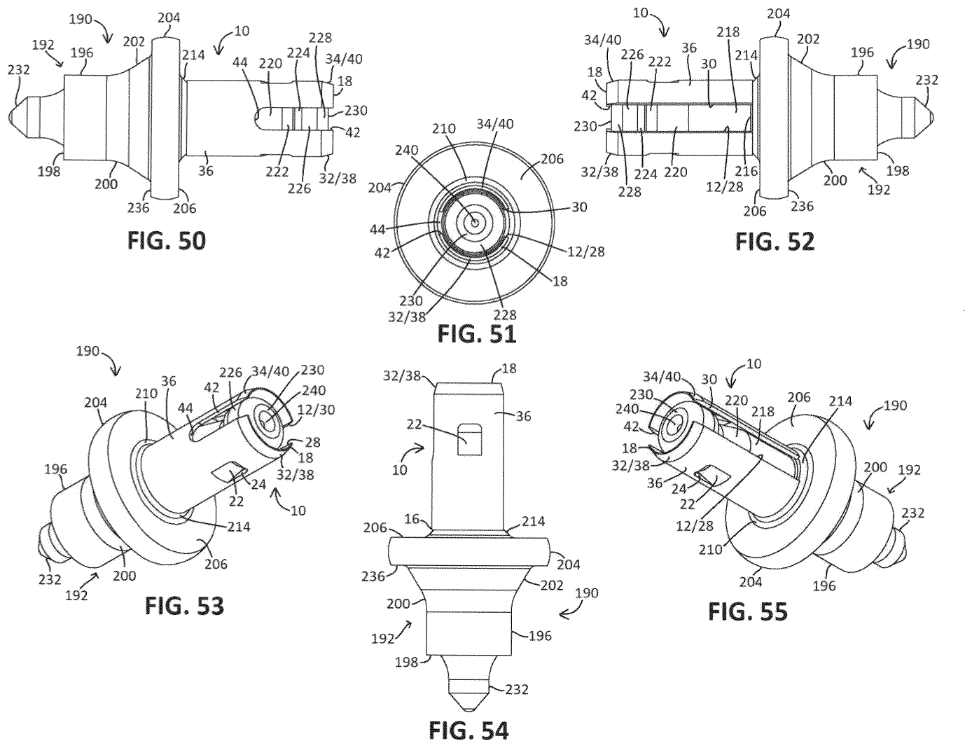

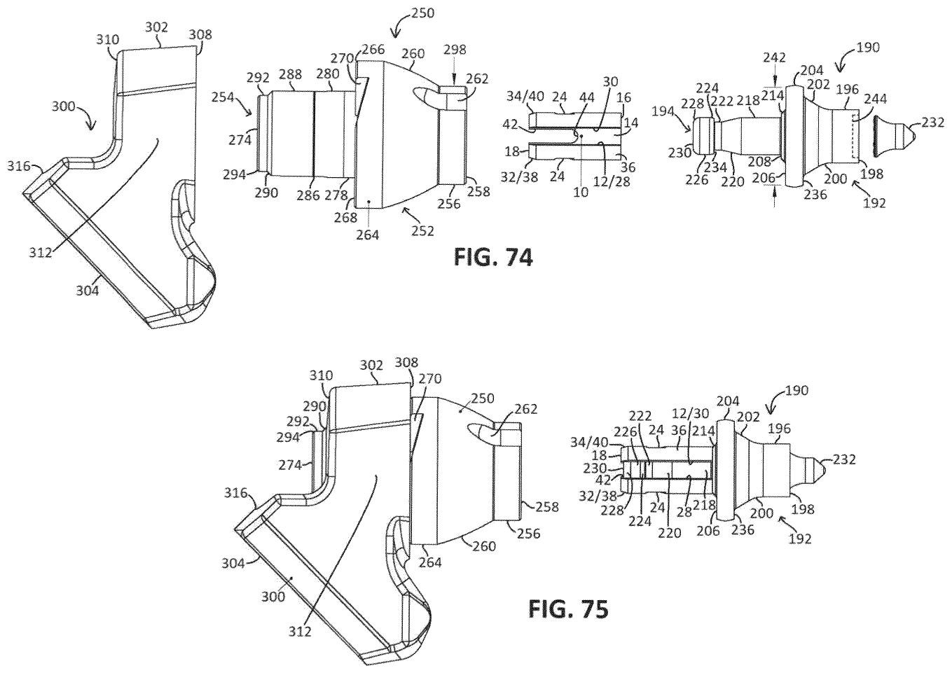

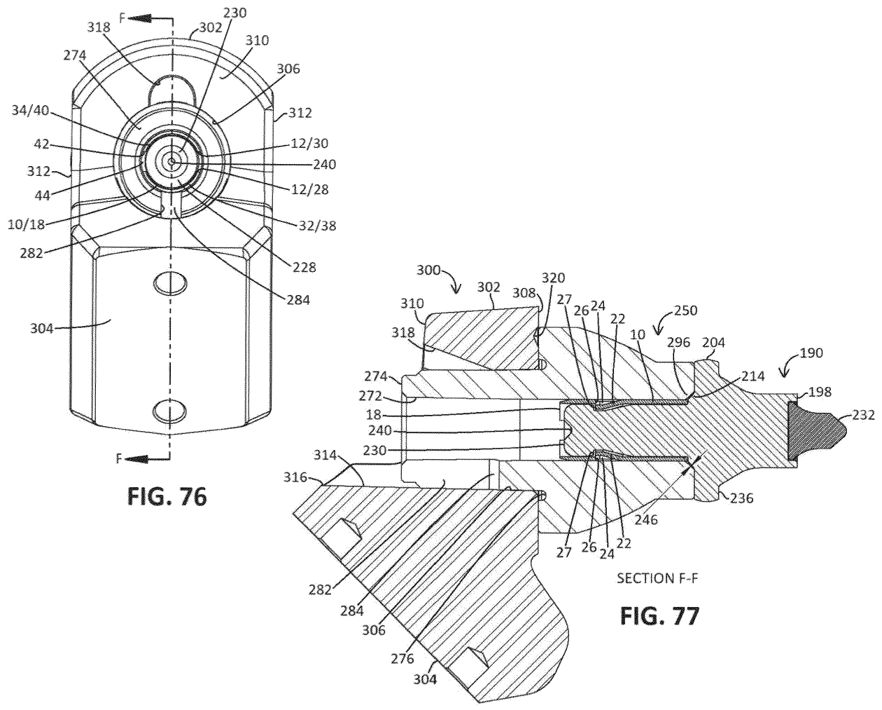

The retainer 10 comprises at least one axially and radially inwardly extending axial locator tab 22 comprising a forward end that is a predetermined distance from the forward end 16 of the retainer 10. In this exemplary illustrated implementation, retainer 10 comprises two axial locator tabs 22 that axially extend to a distal end 27 of the tab 22 adjacent the distal end 18 of the retainer 10 and are approximately 180 degrees apart, in this exemplary illustrated implementation, from one another. The two axial locator tabs 22 are each radially inwardly positioned on a portion of the retainer 10, forming a tab aperture 24 on the wall of the retainer 10 that terminates at a distal end 26 of the tab aperture 24. The distal end 27 of the tabs 22 is adapted to engage a recess or flange 234 (FIG. 74) adjacent a distal end 230 (FIGS. 50-53, 55 and 74-77) of a shank 194 of a bit 190 (FIGS. 50-55 and 74-77) to prevent the retainer 10 from being removed from the bit shank 194 when the bit 190 is extracted from the bore 272 of the bit holder 250 (FIGS. 74-77). In the exemplary illustrated embodiments described herein, the retainers include two axially and radially inwardly extending tabs. In other embodiments, the retainer can include any number of axially and radially inwardly extending tabs. In yet another embodiment, the retainer 10 can comprise at least one aperture (not shown) that is a predetermined distance from the forward end 16 of the retainer 10. In yet other embodiments, the retainers described herein can simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above.

The retainer 10 comprises a compression slot 42, disposed between the lead-in chamfers 32, 34, that axially extends from a central portion of a back axial portion of the retainer 10 adjacent the distal end 18 of the retainer 10 to a slot termination 44 located a predetermined distance from the distal end 18 of the retainer 10. In this exemplary illustrated implementation, the slot termination 44 of compression slot 42 is axially forward of the forward end of the tab 22 and adjacent the forward end 16 of the retainer 10.

As with the embodiments of the retainers described herein, the lead-in chamfers 32, 34 allow about 50% less distal end 18 contact at the contact surfaces 38, 40, respectively, on the retainer 10 with the inner wall of a countersink 296 of the bore 272 of the bit holder 250, which is beneficial during the initial insertion of the retainer 10 into the bore 272 of the bit holder 250. During insertion, the direction of collapse 46 (FIG. 8) is radial, occurring initially adjacent the distal end 18 of the retainer 10. The addition of the lead-in chamfers 32, 34 and the compression slot 42 allows for easier insertion of the distal end 18 of the retainer 10 into the bore 272 of the bit holder 250.

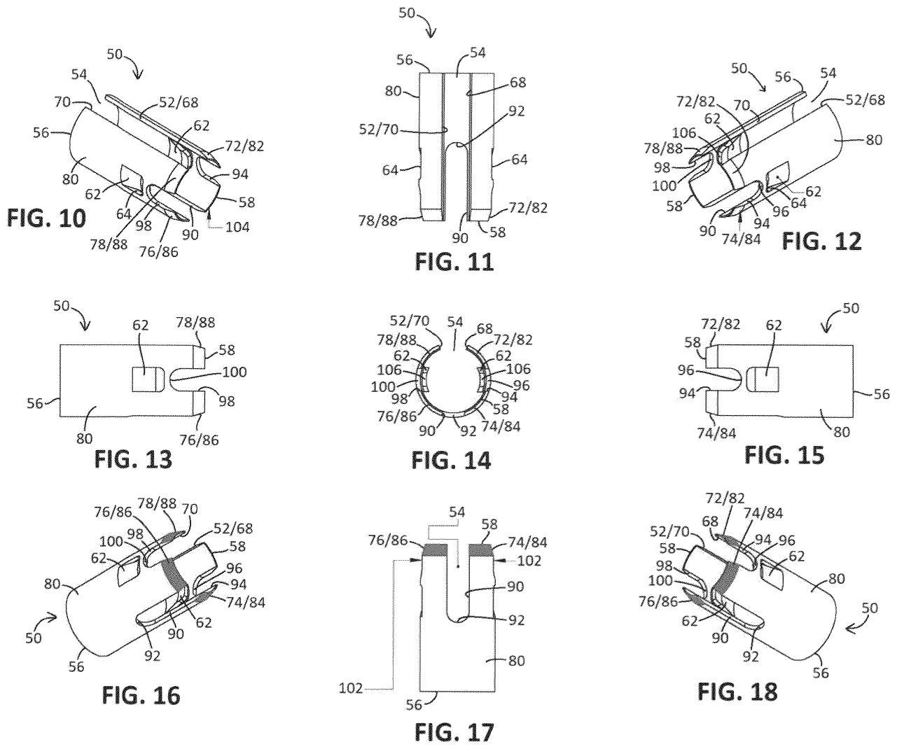

Referring to FIGS. 10-18, a second illustrated embodiment of a retainer 50 is shown in accordance with implementations of this disclosure. Retainer 50 comprises a slot 52 axially extending from a forward end 56 of the retainer 50 to a distal end 58 of the retainer 50. The slot 52 includes a gap profile 54 that is defined by a first radial end surface 68 of the slot 52 and a second radial end surface 70 of the slot 52. In this exemplary illustrated implementation, the radial end surfaces 68, 70 are linear throughout their axial length thereby defining the linear gap profile 54. In alternate embodiments of the retainers described herein, the radial end surfaces 68, 70 and the gap profile 54 may be parallel, serpentine, arcuate, angular, zig-zagged, or any other configuration that can be formed by the radial end surfaces 68, 70 of the slot 52 or combination of same.

The retainer 50 comprises at least one lead-in chamfer. In this exemplary illustrated implementation, the retainer 50 comprises four lead-in chamfers 72, 74, 76, 78 that each comprise a generally 0.002-0.035 inch height and a length that is greater than the height of the chamfers 72, 74, 76, 78, as shown in FIGS. 11, 13, 15, and 17. For explanatory and exemplary purposes only, assuming the retainer 50 is generally 0.050 inch thick, a chamfer 72, 74, 76, 78 including a height of 0.002 inch results in a 0.048 inch retainer thickness at the distal end 58 of the retainer 50 while a chamfer 72, 74, 76, 78 including a height of 0.035 inch results in a 0.015 inch retainer thickness at the distal end 58 of the retainer 50.

In this exemplary illustrated implementation, chamfers 72, 74, 76, 78 extend axially from the distal end 58 of the retainer 50 to an outer surface 80 of the retainer 50 and extend radially and circumferentially around the retainer 50 adjacent the distal end 58 from compression slot 94 to the first radial end surface 68, from compression slot 90 to compression slot 94, from compression slot 98 to compression slot 90, and from compression slot 98 to the second radial end surface 70, respectively. The lead-in chamfers 72, 74, 76, 78 allow about 50% less distal end 58 contact at a first contact surface 82, a second contact surface 84, a third contact surface 86, and a fourth contact surface 88, respectively, on the retainer 50 with the inner wall of the bore 272 of the bit holder 250, described below, which is beneficial during the initial insertion of the retainer 50 into the bore 272 of the bit holder 250.

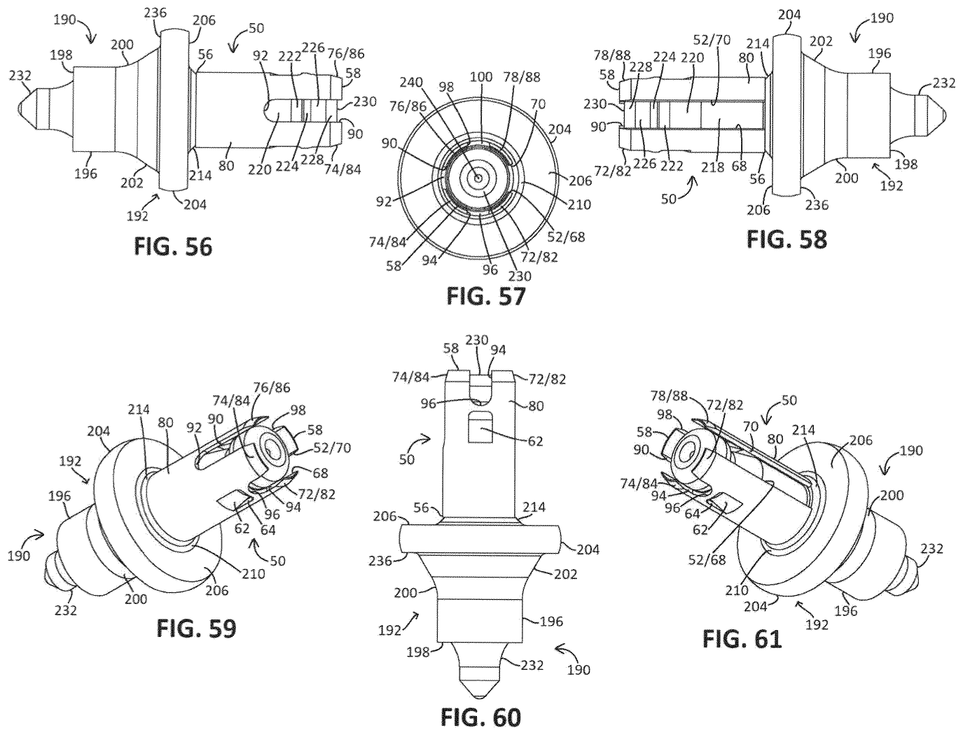

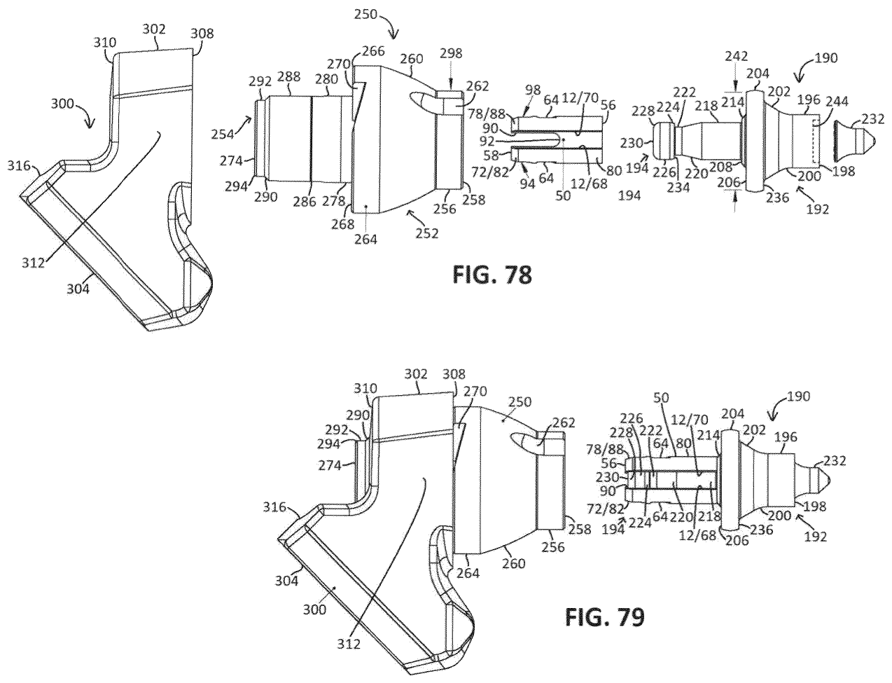

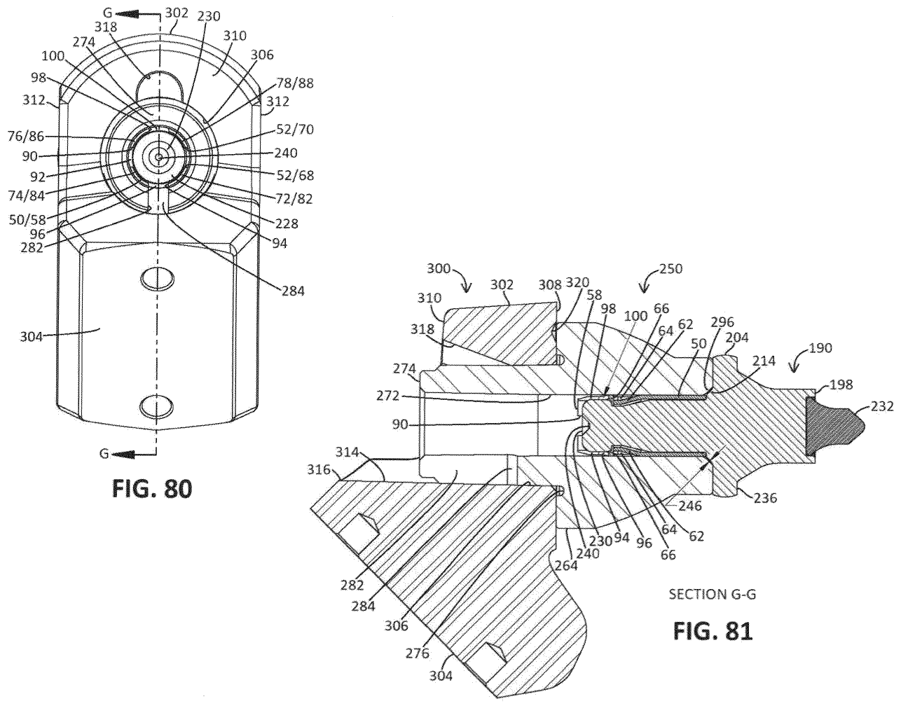

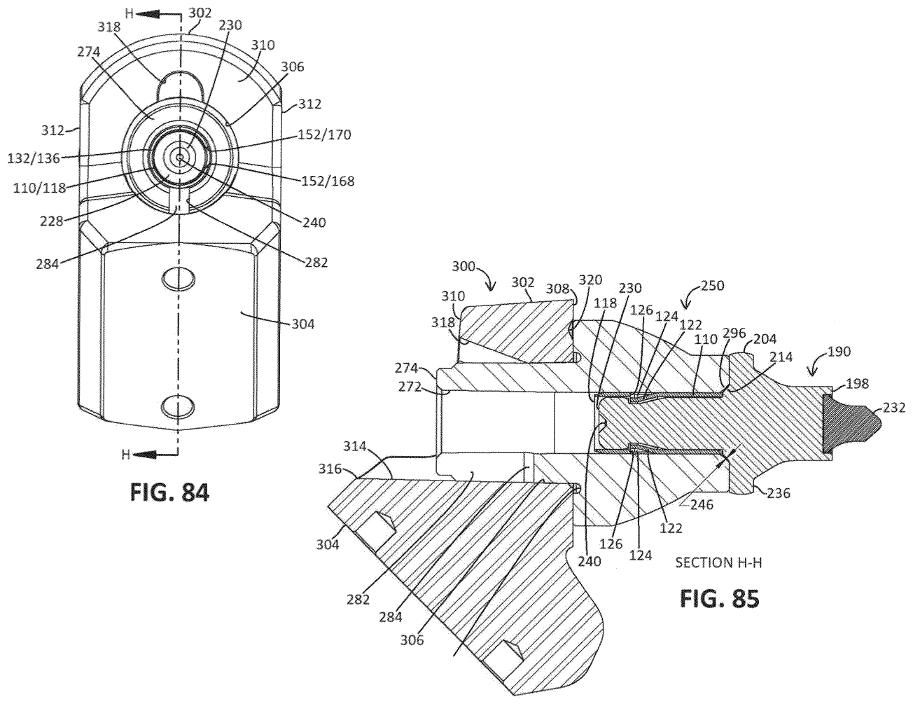

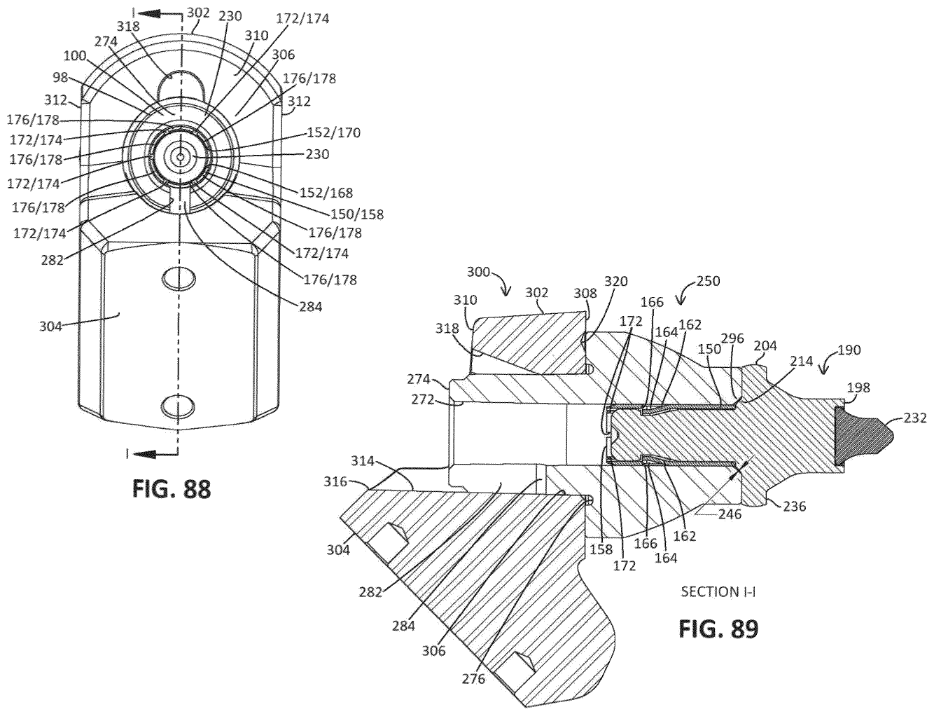

The retainer 50 comprises at least one axially and radially inwardly extending axial locator tab 62 comprising a forward end that is a predetermined distance from the forward end 56 of the retainer 50. In this exemplary illustrated implementation, retainer 50 comprises two axial locator tabs 62 that axially extend to a distal end 106 of the tab 62 adjacent the distal end 58 of the retainer 50 and are approximately 180 degrees apart, in this exemplary illustrated implementation, from one another. The two axial locator tabs 62 are each radially inwardly positioned on a portion of the retainer 50, forming a tab aperture 64 on the wall of the retainer 50 that terminates at a distal end 66 of the tab aperture 64. The distal ends 106 of the tabs 62 are adapted to engage the recess or flange 234 (FIG. 78) adjacent the distal end 230 (FIGS. 56-58, 60, and 78-81) of the shank, 194 of the bit 190 (FIGS. 56-61 and 78-81) to prevent the retainer 50 from being removed from the bit shank 194 when the bit 190 is extracted from the bore 272 of the bit holder 250 (FIGS. 74-89). In the exemplary illustrated embodiments described herein, the retainers include two axially and radially inwardly extending tabs. In other embodiments, the retainer can include any number of axially and radially inwardly extending tabs. In yet another embodiment, the retainer 50 can comprise at least one aperture (not shown) that is a predetermined distance from the forward end 56 of the retainer 50. In yet other embodiments, the retainers described herein can simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above.

The retainer 50 comprises a primary compression slot 90, disposed between lead-in chamfers 74, 76, that axially extends from a central portion of a back axial portion of the retainer 50 adjacent the distal end 58 of the retainer 50 to a slot termination 92 located a predetermined distance from the distal end 58 of the retainer 50. In this exemplary illustrated implementation, the slot termination 92 of primary compression slot 90 is axially forward of the forward end of the tab 62. The retainer 50 also comprises at least one secondary compression slot. In this exemplary illustrated implementation, retainer 50 comprises two secondary compression slots 94, 98 that axially extend from the distal end 58 of the retainer 50 to a slot termination 96, 100, respectively. The first secondary compression slot 94 is disposed between lead-in chamfers 72, 74 and the second secondary compression slot 98 is disposed between lead-in chamfers 76, 78. respectively. In this exemplary illustrated implementation, the slot terminations 96, 100 of the secondary compression slots 94, 98, respectively, are adjacent the distal end 66 of the tab aperture 64.

As with the embodiments of the retainers described herein, the lead-in chamfers 72, 74, 76, 78 allow about 50% less distal end 58 contact at the contact surfaces 82, 84, 86, 88, respectively, on the retainer 50 with the inner wall of the countersink 296 of the bore 272 of the bit holder 250, which is beneficial during the initial insertion of the retainer 50 into the bore 272 of the bit holder 250. During insertion, the direction of collapse 102 (FIG. 17) is radial, occurring initially adjacent the distal end 58 of the retainer 50. The addition of the lead-in chamfers 72, 74, 76, 78, the primary compression slot 90, and the two secondary compression slots 94, 98 allows for easier insertion of the distal end 58 of the retainer 50 into the bore 272 of the bit holder 250.

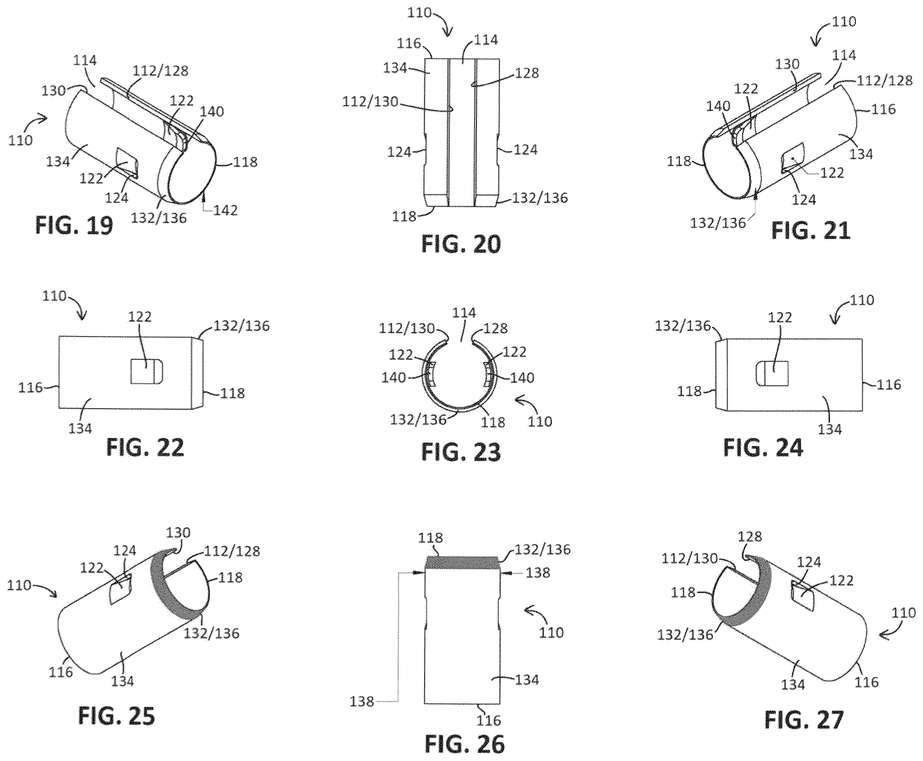

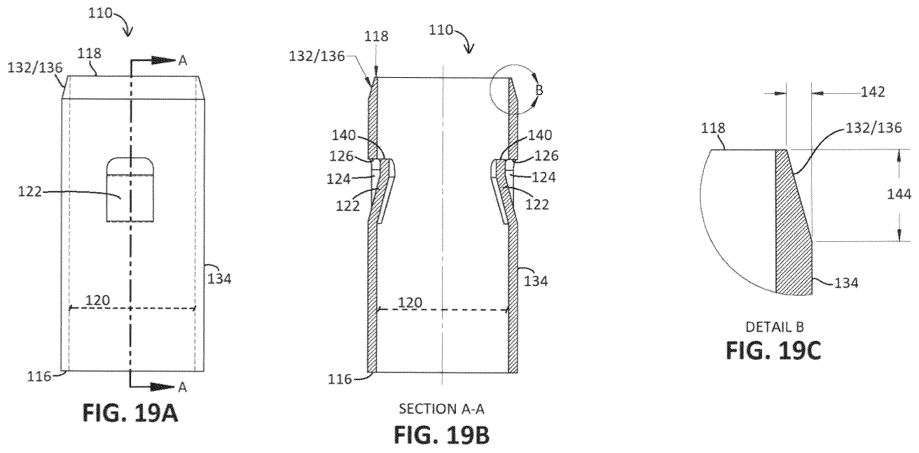

Referring to FIGS. 19, 19A-19C, and 20-27, a third illustrated embodiment of a retainer 110 is shown in accordance with implementations of this disclosure. Retainer 110 includes a slot 112 axially extending from a forward end 116 of the retainer 110 to a distal end 118 of the retainer 110. The slot 112 comprises a gap profile 114 that is defined by a first radial end surface 128 of the slot 112 and a second radial end surface 130 of the slot 112. In this exemplary illustrated implementation, the radial end surfaces 128, 130 are linear throughout their axial length thereby defining a linear gap profile 114. In alternate embodiments of the retainers described herein, the radial end surfaces 128, 130 and the gap profile 114 may be parallel, serpentine, arcuate, angular, zig-zagged, or any other configuration that can be formed by the radial end surfaces 128, 130 of the slot 112 or combination of same.

The retainer 110 comprises at least one lead-in chamfer. In this exemplary illustrated implementation, the chamfer 132 comprises a generally 0.002-0.035 inch height 142 and a length 144 that is application specific. The length 144 of the chamfer 132 is greater than the height 142 of the chamfer 132. For explanatory and exemplary purposes only, assuming the retainer 110 is generally 0.050 inch thick, a chamfer 132 including a height 142 of 0.002 inch results in a 0.048 inch retainer thickness at the distal end 118 of the retainer 110 while a chamfer 132 including a height 142 of 0.035 inch results in a 0.015 inch retainer thickness at the distal end 118 of the retainer 110.

In this exemplary illustrated implementation, retainer 110 comprises one lead-in chamfer 132 that extends axially from the distal end 118 of the retainer 110 to an outer surface 134 of the retainer 110 and extends radially and circumferentially around the retainer 110 adjacent the distal end 118 from the first radial end surface 128 to the second radial end surface 130 of the slot 112. The lead-in chamfer 132 allows about 50% less distal end 118 contact at a contact surface 136 on the retainer 110 with the inner wall of the bore 272 of the bit holder 250, which is beneficial during the initial insertion of the retainer 110 into the bore 272 of the bit holder 250.

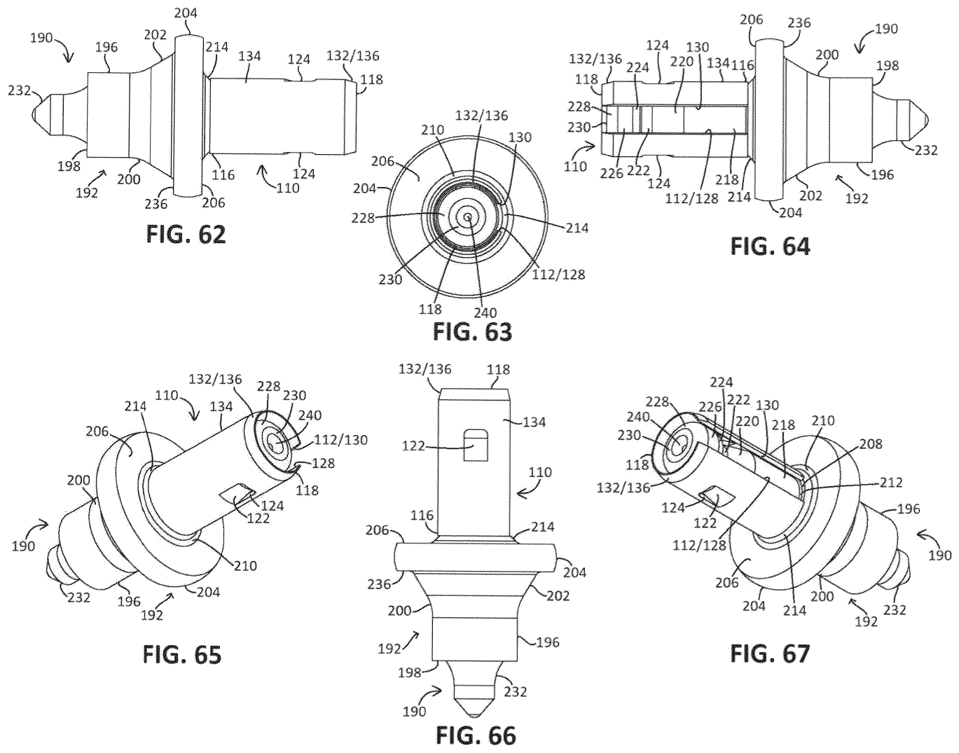

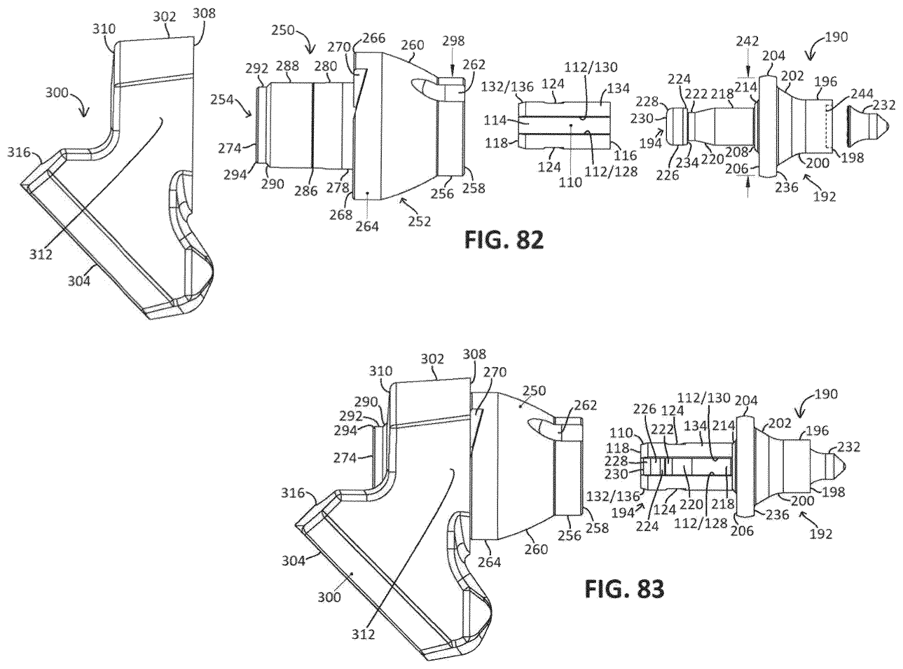

The retainer 110 comprises at least one axially and radially inwardly extending axial locator tab 122 comprising a forward end that is a predetermined distance from the forward end 116 of the retainer 110. In this exemplary illustrated implementation, retainer 110 comprises two axial locator tabs 122 that axially extend to a distal end 140 of the tab 122 adjacent the distal end 118 of the retainer 110 and are approximately 180 degrees apart, in this exemplary illustrated implementation, from one another. The two axial locator tabs 122 are each radially inwardly positioned on a portion of the retainer 110, forming a tab aperture 124 on the wall of the retainer 110 that terminates at a distal end 126 of the tab aperture 124. The distal ends 140 of the tabs 122 are adapted to engage the flange 234 (FIG. 82) adjacent the distal end 230 (FIGS. 63-65, 67, and 82-85) of the shank 194 of the bit 190 (FIGS. 62-67 and 82-85) to prevent the retainer 110 from being removed from the bit shank 194 when the bit 190 is extracted from the bore 272 of the bit holder 250 (FIGS. 74-89). In the exemplary illustrated embodiments described herein, the retainers include two axially and radially inwardly extending tabs. In other embodiments, the retainer can include any number of axially and radially inwardly extending tabs. In yet another embodiment, the retainer 110 can comprise at least one aperture (not shown) that is a predetermined distance from the distal end 118 of the retainer 110. In yet other embodiments, the retainers described herein can simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above.

As with the embodiments of the retainers described herein, the lead-in chamfer 132 allows about 50% less distal end 118 contact at the contact surface 136 on the retainer 110 with the inner wall of the countersink 296 of the bore 272 of the bit holder 250, which is beneficial during the initial insertion of the retainer 110 into the bore 272 of the bit holder 250. During insertion, the direction of collapse 138 (FIG. 26) is radial, occurring initially adjacent the distal end 118 of the retainer 110. The addition of the lead-in chamfer 132 allows for easier insertion of the distal end 118 of the retainer 110 into the bore 272 of the bit holder 250.

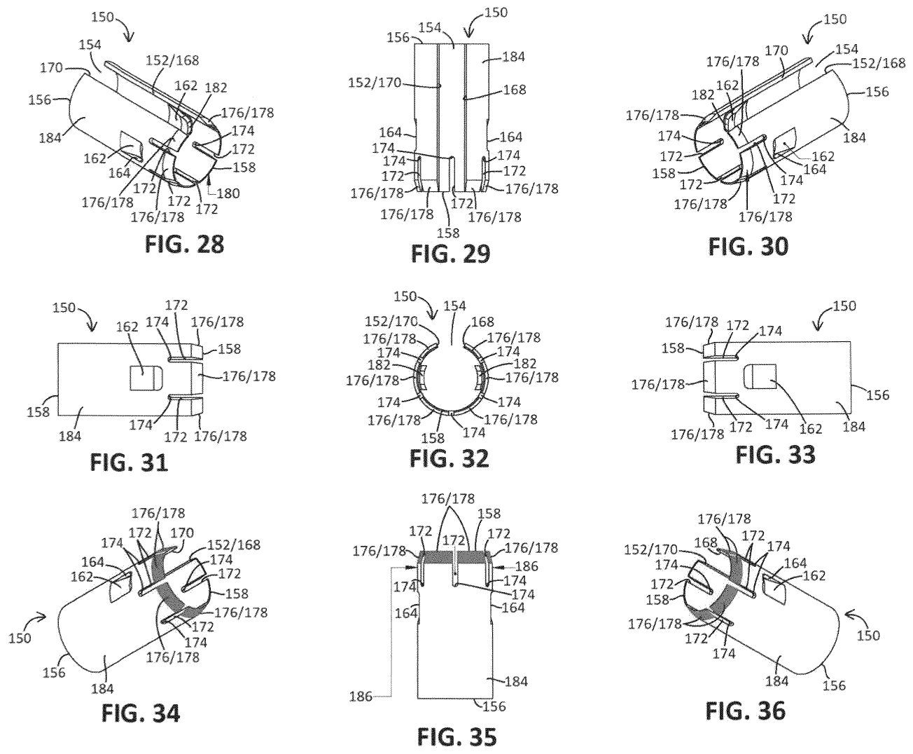

Referring to FIGS. 28-36, a fourth illustrated embodiment of a retainer 150 is shown in accordance with implementations of this disclosure. Retainer 150 comprises a slot 152 axially extending from a forward end 156 of the retainer 150 to a distal end 158 of the retainer 150. The slot 152 includes a gap profile 154 that is defined by a first radial end surface 168 of the slot 152 and a second radial end surface 170 of the slot 152. In this exemplary illustrated implementation, the radial end surfaces 168, 170 are linear throughout their axial length thereby defining the linear gap profile 154. In alternate embodiments of the retainers described herein, the radial end surfaces 168, 170 and the gap profile 154 may be parallel, serpentine, arcuate, angular, zig-zagged, or any other configuration that can be formed by the radial end surfaces 168, 170 of the slot 152 or combination of same.

The retainer 150 comprises at least one lead-in chamfer. In this exemplary illustrated implementation, the retainer 150 comprises a plurality of lead-in chamfers 176 that each comprise a generally 0.002-0.035 inch height and a length that is greater than the height of the chamfers 176, as shown in FIGS. 29, 31, 33, and 35. For explanatory and exemplary purposes only, assuming the retainer 150 is generally 0.050 inch thick, a chamfer 176 including a height of 0.002 inch results in a 0.048 inch retainer thickness at the distal end 158 of the retainer 150 while a chamfer 176 including a height of 0.035 inch results in a 0.015 inch retainer thickness at the distal end 158 of the retainer 150.

In this exemplary illustrated implementation, chamfers 176 extend axially from the distal end 158 of the retainer 150 to an outer surface 184 of the retainer 150 and extend radially and circumferentially around the retainer 150 adjacent the distal end 158 from the first radial end surface 168 to compression slot 172, from compression slots 172 to compression slots 172, and from compression slot 172 to the second radial end surface 170, respectively. The lead-in chamfers 176 allow about 50% less distal end 158 contact at contact surfaces 178 on the retainer 150 with the inner wall of the bore 272 of the bit holder 250, described below, which is beneficial during the initial insertion of the retainer 150 into the bore 272 of the bit holder 250.

The retainer 150 also comprises at least one compression slot. The lead-in chamfers 176 are defined by the compression slot(s) in that at least one of the radial ends of each lead-in chamfer 176 includes a sidewall of a compression slot. In this exemplary illustrated implementation, retainer 150 comprises five compression slots 172 that each axially extend from the distal end 158 of the retainer 150 to their respective slot terminations 174. Each compression slot 172 is disposed circumferentially around the distal end 158 of the retainer 150, each compression slot 172 disposed between a pair of the lead-in chamfers 176. In this exemplary illustrated implementation, the slot terminations 174 of the compression slots 172 are adjacent the distal ends 166 of the tab apertures 164.

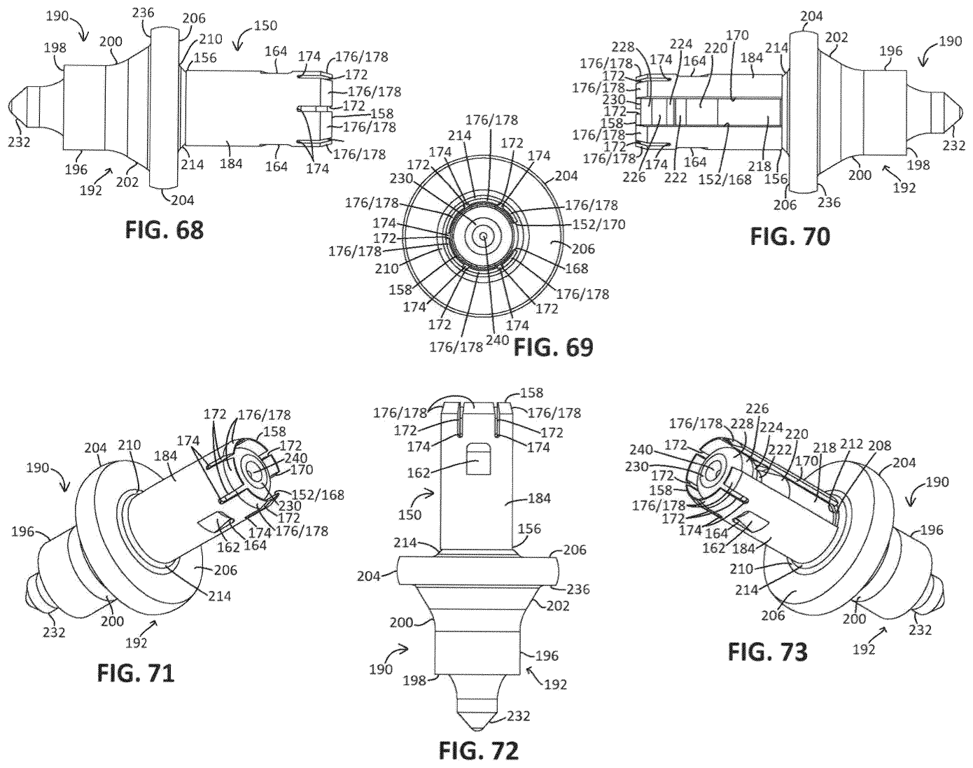

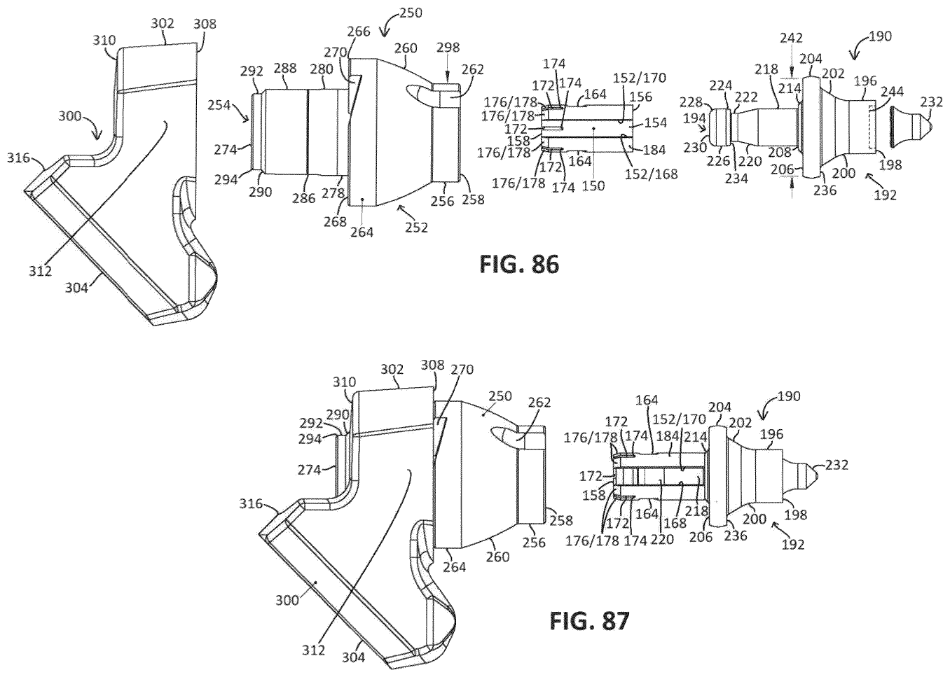

The retainer 150 comprises at least one radially inwardly and axially extending axial locator tab 162 comprising a forward end that is a predetermined distance from the forward end 156 of the retainer 150. In this exemplary illustrated implementation, retainer 150 comprises two axial locator tabs 162 that axially extend to a distal end 182 of the tab 162 adjacent the distal end 158 of the retainer 150 and are approximately 180 degrees apart, in this exemplary illustrated implementation, from one another. The two axial locator tabs 162 are each radially inwardly positioned on a portion of the retainer 150, forming a tab aperture 164 on the wall of the retainer 150 that terminates at a distal end 166 of the tab aperture 164. The distal ends 182 of the tabs 162 are adapted to engage the flange 234 (FIG. 86) adjacent the distal end 230 (FIGS. 68-71, 73, and 86-89) of the shank 194 of the bit 190 (FIGS. 69-73 and 86-89) to prevent the retainer 150 from being removed from the bit shank 194 when the bit 190 is extracted from the bore 272 of the bit holder 250 (FIGS. 74-89). In the exemplary illustrated embodiments described herein, the retainers include two axially and radially inwardly extending tabs. In other embodiments, the retainer can include any number of axially and radially inwardly extending tabs. In yet another embodiment, the retainer 150 can comprise at least one aperture (not shown) that is a predetermined distance from the distal end 158 of the retainer 150. In yet other embodiments, the retainers described herein can simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above.

As with the embodiments of the retainers described herein, the lead-in chamfers 176 allow about 50% less distal end 158 contact at contact surfaces 178 on the retainer 150 with the inner wall of the countersink 296 of the bore 272 of the bit holder 250, which is beneficial during the initial insertion of the retainer 150 into the bore 272 of the bit holder 250. During insertion, the direction of collapse 186 (FIG. 35) is radial, occurring initially adjacent the distal end 158 of the retainer 150. The addition of the lead-in chamfers 176 and the compression slots 172 allows for easier insertion of the distal end 158 of the retainer 150 into the bore 272 of the bit holder 250.

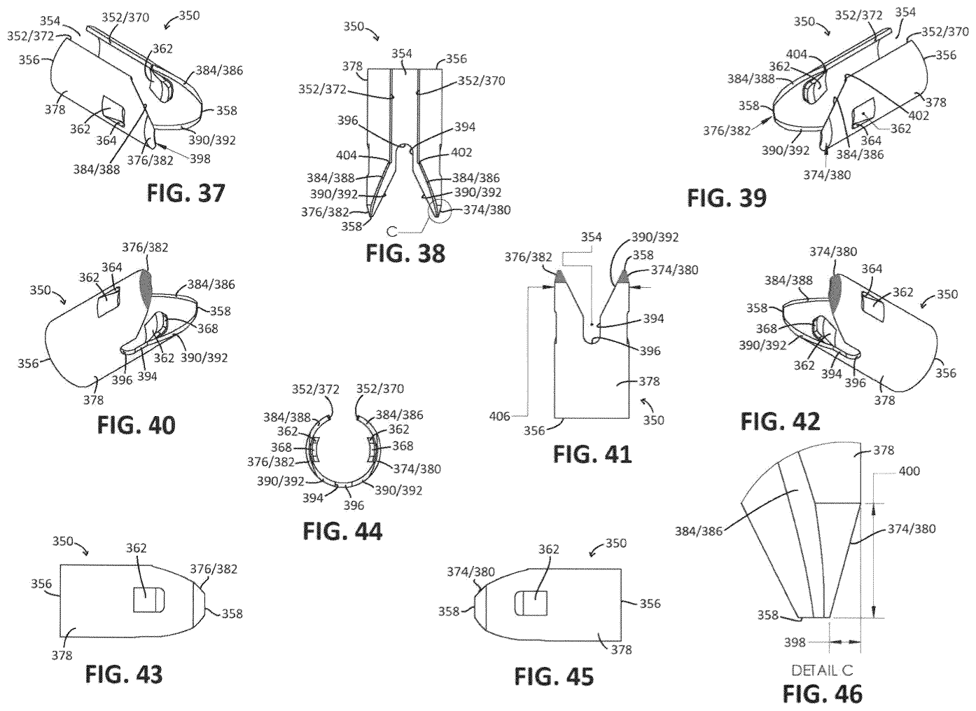

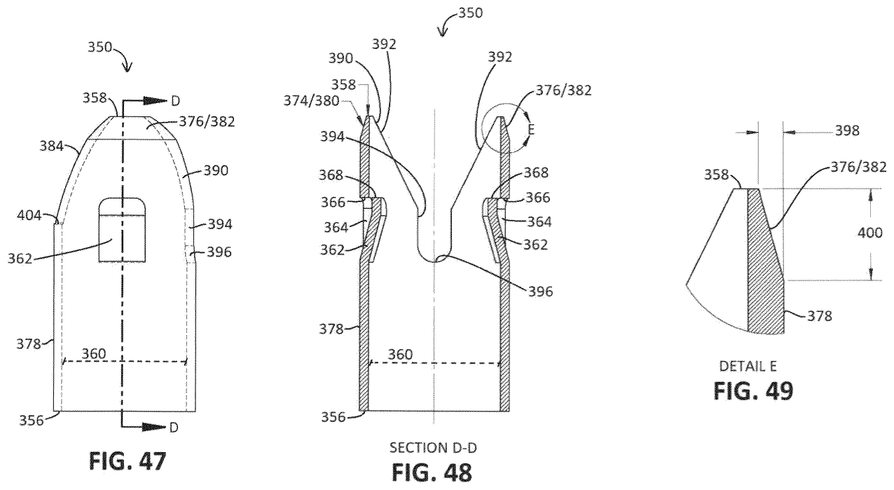

Referring to FIGS. 37-49, a fifth illustrated embodiment of a retainer 350 is shown in accordance with implementations of this disclosure. Retainer 350 includes a slot 352 axially extending from a forward end 356 of the retainer 350 to a distal end 358 of the retainer 350. The slot 352 comprises a gap profile 354 that is defined by a first radial end surface 370 of the slot 352 and a second radial end surface 372 of the slot 352. In this exemplary illustrated implementation, the radial end surfaces 370, 372 are linear throughout their axial length thereby defining a linear gap profile 354. In alternate embodiments, the radial end surfaces 370, 372 and the gap profile 354 may be parallel, serpentine, arcuate, angular, zig-zagged, or any other configuration that can be formed by the radial end surfaces 370, 372 of the slot 352 or combination of same.

The retainer 350 comprises at least one lead-in chamfer. In this exemplary illustrated implementation, the retainer 350 comprises two lead-in chamfers 374, 376 that each comprise a generally 0.002-0.035 inch height 398 and a length 400 that is greater than the height 398 of the chamfers 374, 376, as shown in FIGS. 46 and 49. For explanatory and exemplary purposes only, assuming the retainer 350 is generally 0.050 inch thick, a chamfer 374, 376 including a height 398 of 0.002 inch results in a 0.048 inch retainer thickness at the distal end 358 of the retainer 350 while a chamfer 374, 376 including a height 398 of 0.035 inch results in a 0.015 inch retainer thickness at the distal end 358 of the retainer 350.

In this exemplary illustrated implementation, chamfers 374, 376 extend axially from the distal end 358 of the retainer 350 to an outer surface 378 of the retainer 350 and extend radially and circumferentially around the retainer 350 adjacent the distal end 358 from a relief notch 390 at the distal end 358 of the retainer 350, described below, to the first radial end surface 370 and the second radial end surface 372 of the slot 352, respectively. The lead-in chamfers 374, 376 allow about 50% less distal end 358 contact at a first contact surface 380 and a second contact surface 382, respectively, on the retainer 350 with the inner wall of the bore 272 of the bit holder 250, described below, which is beneficial during the initial insertion of the retainer 350 into the bore 272 of the bit holder 250.

The retainer 350 comprises a first angled portion 386 that extends from the distal end 358 of the retainer 350 to the first radial end surface 370 of the slot 352 and a second angled portion 388 that extends from the distal end 358 of the retainer 350 to the second radial end surface 372 of the slot 352. A dual corner break 384 is formed by the first angled portion 386 and the second angled portion 388, which allows for good and/or easier insertion of the distal end 358 of the retainer 350, disposed circumferentially about the shank 194 of the bit 190, into the bore 272 of the bit holder 250.

The retainer 350 further comprises at least one radially inwardly and axially extending axial locator tab 362 comprising a forward end that is a predetermined distance from the forward end 356 of the retainer 350. In this exemplary illustrated implementation, retainer 350 comprises two axial locator tabs 362 that axially extend to a distal end 368 of the tab 362 adjacent the distal end 358 of the retainer 350 and are approximately 180 degrees apart, in this exemplary illustrated implementation, from one another. The two axial locator tabs 362 are each radially inwardly positioned on a portion of the retainer 350, forming a tab aperture 364 on the wall of the retainer 350 that terminates at a distal end 366 of the tab aperture 364. The distal ends 368 of the tabs 362 are adapted to engage the flange 234 adjacent the distal end 230 of the shank 194 of the bit 190 to prevent the retainer 350 from being removed from the bit shank 194 when the bit 190 is extracted from the bore 272 of the bit holder 250. In the exemplary illustrated embodiments described herein, the retainers include two axially and radially inwardly extending tabs. In other embodiments, the retainer can include any number of axially and radially inwardly extending tabs. In yet another embodiment, the retainer 350 can comprise at least one aperture (not shown) that is a predetermined distance from the distal end 358 of the retainer 350. In yet other embodiments, the retainers described herein can simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above.

The retainer 350 comprises the relief notch or v-notch 390, which is angular in this exemplary illustrated implementation, extending from the distal end 358 of the retainer 350 to a location axially forward of the distal end 366 (FIG. 48) of the tab aperture 364. The relief notch 360 comprises a pair of angular sides 392 (FIGS. 38, 41, and 48) that axially extend from the distal end 358 of the retainer 350 to a compression slot 394 (FIGS. 38, 41, and 48). The compression slot 394 axially extends from a central portion of the relief notch 390 to a slot termination 396 located axially forward of the forward ends 402, 404, shown in FIG. 38, of the first and second angled portions 386, 388, respectively, of the dual corner break 384.

As with the embodiments of the retainers described herein, the lead-in chamfers 374, 376 allow about 50% less distal end 358 contact at contact surfaces 380, 382 on the retainer 350 with the inner wall of the countersink 296 of the bore 272 of the bit holder 250, which is beneficial during the initial insertion of the retainer 350 into the bore 272 of the bit holder 250. During insertion, the direction of collapse 406 (FIG. 41) is radial, occurring initially adjacent the distal end 358 of the retainer 350. The addition of the lead-in chamfers 380, 382 and the compression slot 394 allows for easier insertion of the distal end 358 of the retainer 350 into the bore 272 of the bit holder 250.

Referring to FIGS. 50-89, a first illustrated embodiment of a bit 190 comprises a bit body 192 and a bit shank 194 axially depending from a bottom of the bit body 192. The bit body 192 is generally cylindrical or generally annular in shape and comprises an annular or generally cylindrical top surface 198, such as a nearly flat annular top surface in the first illustrated embodiment, adjacent to an annular or generally cylindrical upper body portion 196 that includes an annular or generally cylindrical trough 244 (FIGS. 74, 78, 82, and 86) in which to retain a bit tip 232. An arcuate or concave first mediate body portion 200 adjacent the upper body portion 196 generally slopes axially and radially outwardly to an angular or conical second mediate body portion 202. In other embodiments, the first mediate body portion 200 and the second mediate body portion 202 can have a frustoconical shape, an arcuate shape, a convex shape, a concave shape, and/or any combination of same. The angular body portion 202 extends axially to a forward surface 236, which is planar in this illustrated embodiment, of a radially extending generally arcuate enlarged washer feature or portion 204. The planar surface 236 of the washer feature 204 serves as a cut-material flow barrier that axially forces the rear annular flange 206 of the bit body 192 against a forward face 258 of the bit holder 250 with a greater force than a frustoconical profile on the forward end of the bit body.

The washer feature 204 comprises an outer diameter 242 that is, in this exemplary illustrated implementation, generally the same as a diameter of a nose portion 298 of the bit holder 250, as shown in FIGS. 77, 81, 85, and 89. In other embodiments, the diameter of the washer feature 204 can be at least the diameter of the nose portion 298 of the bit holder 250 or greater than the diameter of the nose portion 298 of the bit holder 250. The washer feature 204 of the bit body 192 is located in a forward position from a first flange 206 that denotes a bottom of the bit body 192 (FIGS. 50-75, 78, 79, 82, 83, 86, and 87). A decreased diameter tapered distal portion 214 extends from the first flange 206 of the washer feature 204 of the bit body 192 to a second flange 208 (FIGS. 74, 78, 82, and 86) at a distal end of the angular portion 214 adjacent a forward end 216 of the shank 194. In this exemplary illustrated implementation, the thickness or axial length of the washer feature 204, measured from the first flange 206 to the forward surface 236 of the washer feature 204, is generally from about ⅛ inch to ½ inch and is application specific. The first flange 206 and the second flange 208 may be flat, annular, generally cylindrical, and/or any other suitable shape and/or configuration. In this exemplary illustrated implementation, the first flange 206 includes a first transition radius or undercut 210 (FIG. 68) laterally adjacent a forward end of the tapered distal portion 214. The first transition radius 210 is a small radius that transitions from the rear annular flange 206 to the tapered distal portion 214. The second flange 208 also includes a second transition radius or undercut 212 (not shown) laterally adjacent the forward end 216 of the bit shank 194. The second transition radius 212 is also a small radius that transitions from the second flange or shoulder 208 to the forward end 216 of the shank 194.

A unibody is formed in that the washer feature 204 is designed as part of the bit body 192. When the washer feature 204 is incorporated into the bit body 192 as a single component design, the cost of the unibody, i.e., the washer feature 204 and the bit body 192 combination, is about 30%-40% less cost than a two-part washer and cutter bit body configuration of a bit of the prior art.

The bit shank 194 axially depends from the transition radius 212 (not shown) of the second flange 208 adjacent a distal end of the decreased diameter tapered distal portion 214 of the washer feature 204 and is axially aligned with the bit body 192. The shank 194 comprises a generally cylindrical first segment 218 that axially extends from the transition radius 212 of the second flange 208 to a tapered second segment 220. The second segment 220 axially extends from the first segment 218 to a generally cylindrical third segment 222. The third segment 222 axially extends from the second segment 220 to a third flange 234. An outwardly tapered fourth segment 224, adjacent the third flange 234, axially extends to a generally cylindrical fifth segment 226. The fifth segment 226 axially extends to an arcuate sixth segment 228 that is adjacent to a distal end 230 of the bit shank 194. The shank 194 includes a notch 240 that extends inwardly from the distal end 230 of the bit shank 194. In other embodiments, the shank 194 can be cylindrical and/or can include tapered and/or arcuate segments. The distal hub fifth segment 226 of the shank 194 may have a smaller diameter than the forward portion or first segment 218 of the shank 194, thereby reducing or eliminating the interference of cutting fines accumulating between an outer diameter of the of the distal end or fifth segment 226 of the shank 194 and an inner diameter of the retainer 10, 50, 110, 150, 350. The “V” shaped cutouts designed into the distal end of the retainer further improves bit rotation when using the reduced diameter on the distal end 230 of the shank 194.

The shank 194 includes a coaxial and generally cylindrical collapsible slotted

retainer, such as retainers 10, 50, 110, 150 as described herein, that is disposed circumferentially about the shank 194. The retainer is generally made from spring steel or other hardenable material with an elasticity and a durability that allows the retainer to return to its nearly original shape despite significant deflection or twisting.

Referring to FIGS. 74-89, a first illustrated embodiment of the bit holder 250 includes a bit holder body 252 and a bit holder shank 254 axially depending from the bottom of the bit holder body 252. The bit holder body 252 is generally annular in shape and comprises a countersink 296 adjacent a top surface 258, such as a flat annular top surface, at a forward end of the bit holder body 252. An annular or generally cylindrical upper body portion 256 axially extends from the top surface 258 to a middle portion 260 that extends axially and radially outwardly to a radially extending generally cylindrical tire portion 264. The middle portion 260, in this exemplary illustrated implementation, has an arcuate shape. In other embodiments, the middle portion 260 can have a frustoconical shape, a convex shape, a concave shape, and/or any combination of same and the tire portion 264 can have an arcuate shape. A pair of notches 262 are formed into the bit holder body 252 and extend from the flat annular top surface 258 through the upper body portion 256 and partly through the middle portion 260, terminating at a point within the middle portion 260. The notches 262 provide access and leverage for a tool to extract, or knock out, the bit 190 from the bit holder body 252. The bit holder 250 may have many other shapes that are proprietary in design and application specific. Generally, the lure of the bit holders accepts universal shank designs that are application specific.

Adjacent the tire portion 264 is a chamfer or tapered portion 266 that axially extends to a flange 268, such as a flat annular flange, of the bit holder body 252. The tire portion 264 includes a pair of tapered cutouts 270, or wedge-shaped undercuts, to provide access and leverage for a tool to extract the bit holder 250 from a base block 300, described below. The tapered cutouts 270 are formed into the tire portion 264 and extend from the flange 268 adjacent to the tire portion 264. The tapered cutouts 270 include a pair of parallel flat vertical inner surfaces and a pair of flat tapered top surfaces. The outer edge of the flat tapered top surfaces of each tapered cutout 270 is each arcuate in shape to follow the periphery of the tire portion 264.

The bit holder shank 254 axially depends from the flange 268 of the bit holder body 252. The bit holder body 252 and the shank 254 are axially aligned with the bit holder bore 272 that extends from a countersink adjacent the flat annular top surface 258 of the bit holder body 252 to a distal end 274 of the bit holder shank 254. In this illustrated embodiment, the shank 254 includes a shortened 1-½ inch length. In other embodiments, the shank 254 can include the standard 2-⅝ inch length or other suitable length. In this illustrated embodiment, the shank 254 also includes a slot 282 that extends from an upper termination 284 adjacent a forward end of the shank 254 to the distal end 274 of the shank 254. Optionally, or in an alternate embodiment, the shank 254 can also include an internally oriented second slot (not shown) that can be located approximately 180 degrees around the annular shank 254 from the slot 282. This second slot is parallel to the first slot 282 and is an internal slot having a rearward semicircular termination (not shown) inwardly adjacent to the distal end 274 of the shank 254 and a forward semicircular termination (not shown) generally coinciding longitudinally and axially with the upper termination 284 of the slot 282.

The shank 254 comprises an increased diameter shortened top or first segment 278 that axially extends from a rounded junction 276 adjacent the flange 268. A decreased diameter tapered mediate or second segment 280 is adjacent to the increased diameter top segment 278. The decreased diameter mediate segment 280 can be tapered towards the distal end 274 of the shank 254 as shown in this illustrated embodiment or can have a generally cylindrical shape, an arcuate shape, can be tapered towards the increased diameter top segment 278, or any combination of same. The shank 254 also includes an annular shoulder 286 disposed between the decreased diameter mediate segment 280 and a lower or third segment 288. A diameter of the annular shoulder 286 increases, or steps up, as it axially extends from the decreased diameter mediate segment 280 to the lower segment 288. The lower segment 288 may be tapered outwardly, in this illustrated embodiment, as it extends towards the distal end 274 of the shank 254. The lower segment 288 runs axially from the annular shoulder 286 to a stepped shoulder 290 adjacent the distal end 274 of the shank 254. The stepped shoulder 290 is disposed between the lower segment 288 and the distal end 274 of the shank 254. A diameter of the stepped shoulder 290 decreases, or steps down, as it axially extends from the lower segment 288 to a decreased diameter distal or fourth segment 292. The decreased diameter distal segment 292 axially extends from the stepped shoulder 290 to a chamfer or tapered portion 294 adjacent the distal end 274 of the shank 254 and is generally C-shaped when viewed from the distal end 274.

Referring to FIGS. 74-89, a first illustrated embodiment of the base block 300 comprises a base 304 and a shortened front end or shortened bit holder receiving portion 302. The base 304 can be flat or slightly concave to fit a drum or additional mounting plates on which a singular or a plurality of base blocks can be mounted. The shortened front end 302 includes a base block bore 306 that is symmetrical with the bit holder shank 254 along a centerline. The shortened front end 302 and the base block bore 306 extending axially through the shortened front end 302 are shortened to approximately 1.5 inches in length, in this illustrated embodiment, by removing material from the rear of the shortened front end 302. The shortened front end 302 includes, in this embodiment, an indentation 320 on a front face 308 of the base block 300. The shortened front end 302 also includes, in this embodiment, a slot 318 decreasing in radial size from a rear face 310 of the shortened front end 302 to a position mediate and/or adjacent the front face 308. The slot 318 provides added room for a punch (not shown) to operate and push the shank of a bit out of the bit holder. The shortened front end 302 also includes a pair of flat vertical sides 312 that extend near and/or adjacent to the base 304. The flat vertical sides 312 reduce the dimensions of the base block 300, including its width, and allow bit assemblies to be positioned in closer center-to-center axial bit tip orientation in order to degrade the road to a smoother surface.

The base block 300 also includes an arcuate bore 306 extension 314 starting at an inner portion of the base block bore 306 adjacent the rear face 310 of the shortened front end 302 and extending toward a rear 316 of the base block 300. The extension 314 does not serve a function when the base block 300 is used with a shortened shank bit holder 250. However, over time the extreme forces from cutting conditions will wear the base block bore 306 and bit holder shank 254 such that the shortened shank bit holder 250 may not successfully be retained in the base block bore 306 and the shortened shank bit holder 250 must be replaced with a standard 2- 5/8 inch length shank bit holder (not shown). The extension 214 engages the 2-⅝ inch long shank of the standard bit holder adjacent its distal end and provides sufficient radial support against that portion of the shank to retain the standard bit holder in the base block bore 306.

Referring to FIGS. 74-77, to mount the bit 190, including the retainer 10 disposed circumferentially around the bit shank 194, into the bit holder 250 and base block 300 assembly (FIG. 75), the shank 194 of the bit 190 is aligned with the bore 272 of the bit holder 250. The radially collapsible compression slot 42 and the lead-in chamfers 32, 34 of retainer 10 provide for easier insertion of the bit shank 194 into the bore 272 of the bit holder 250.

Referring to FIGS. 78-81, to mount the bit 190, including the retainer 50 disposed circumferentially around the bit shank 194, into the bit holder 250 and base block 300 assembly (FIG. 79), the shank 194 of the bit 190 is aligned with the bore 272 of the bit holder 250. The radially collapsible primary compression slot 90, the two radially collapsible secondary compression slots 94, 98, and the lead-in chamfers 72, 74, 76, 78 of retainer 50 provide for easier insertion of the bit shank 194 into the bore 272 of the bit holder 250.

Referring to FIGS. 82-85, to mount the bit 190, including the retainer 110 disposed circumferentially around the bit shank 194, into the bit holder 250 and base block 300 assembly (FIG. 83), the shank 194 of the bit 190 is aligned with the bore 272 of the bit holder 250. The lead-in chamfer 132 of retainer 110 provide for easier insertion of the bit shank 194 into the bore 272 of the bit holder 250.

Referring to FIGS. 86-89, to mount the bit 190, including the retainer 150 disposed circumferentially around the bit shank 194, into the bit holder 250 and base block 300 assembly (FIG. 87), the shank 194 of the bit 190 is aligned with the bore 272 of the bit holder 250. The radially collapsible plurality of compression slots 172 and the lead-in chamfers 176 of retainer 150 provide for easier insertion of the bit shank 194 into the bore 272 of the bit holder 250.

After the bit 190 is inserted into the bore 272 of the bit holder 250, the retainer 10, 50, 110, 150 is axially fixed in place in a rearward seated position. The axial movement of the bit body 192 is then strictly controlled by the allowable clearance between the length of the bit shank 194 shoulders or flanges 208, 234 and the distal surface(s) 27, 106, 140, 182 of the tab(s) 22, 62, 122, 162, respectively, to the distal end 18, 58, 118, 158 of the retainer 10, 50, 110, 150, respectively. The maximum manufactured tolerance deviation between the shoulder dimensions 208, 234 and the distal surface(s) 27, 106, 140, 182 of the tab(s) 22, 62, 122, 162, respectively, to the distal end 18, 58, 118, 158 of the retainer 10, 50, 110, 150, respectively, in the bit 190 in the exemplary illustrated implementations described herein is an approximate average of 0.025 inch.

When the bit 190 is fully assembled in the bore 272 of the bit holder 250, the tapered distal portion 214 of the bit 190 engages the countersink 296 of the bit holder 250 such that the complementary angles 246 of the tapered distal portion 214 of the bit 190 and the countersink 296 of the bit holder 250 radially align the cutter bit 190 concentric with the bore 272 of the bit holder 250, as shown in FIGS. 77, 81, 85, and 89. The reduced axial movement of the bit body 192 allows the angled portion 214 to engage the countersink 296 that is adjacent the forward end 258 of the bit holder 250.

The angles of the tapered distal portion 214 of the bit 190 and the countersink 296 of the bit holder 250 form the contacting angles 246 (FIGS. 77, 81, 85, and 89) after some use of the cutter bit 190. These contacting angles 246 replicate the same wear pattern as a new bit and new bit holder configuration as the cutter bit is put to use. As the wear pattern progresses, the angle of tapered distal portion 214 will develop a wear pattern that makes contact with the adjacent angled mating surface of countersink 296 and with the forward face 258 of the bit holder 250. This wear-in relationship between the tapered distal portion 214 and the countersink 296 can only occur when there is an integral bit body design that does not allow the washer to move separately to the bit body, i.e., the bit 190 comprising the integral washer feature of the present disclosure.

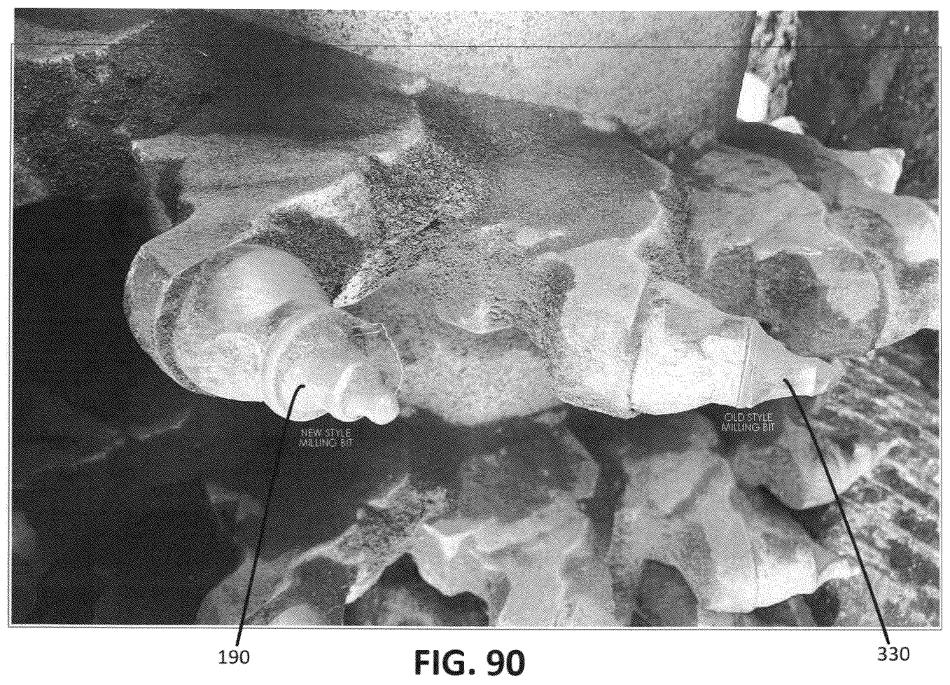

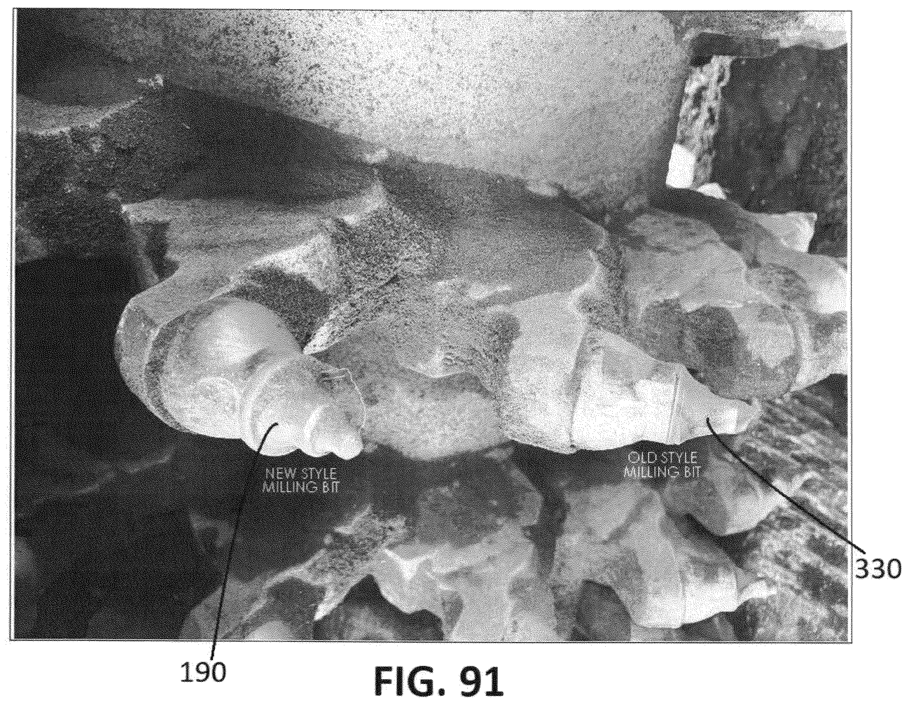

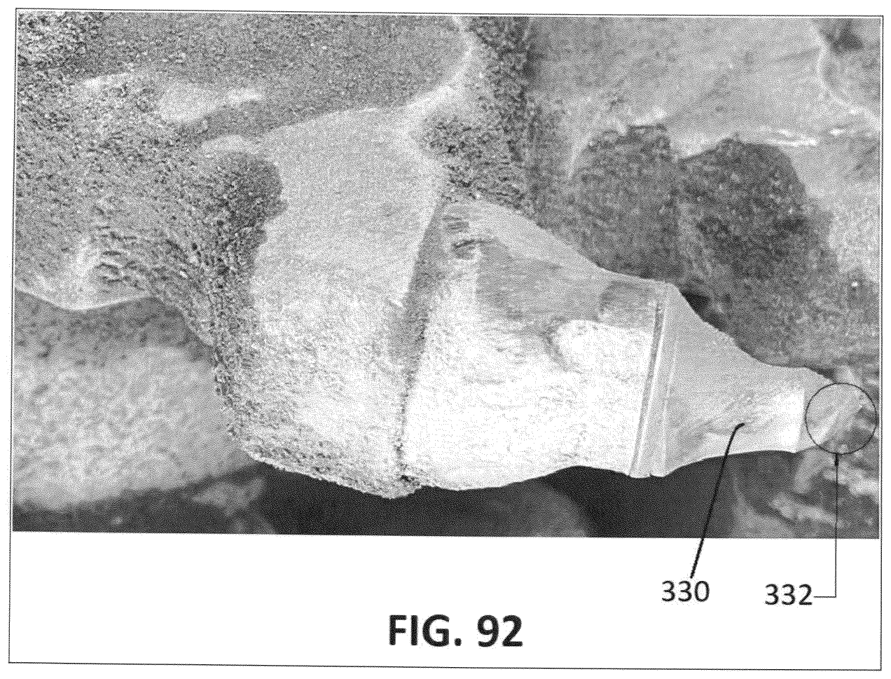

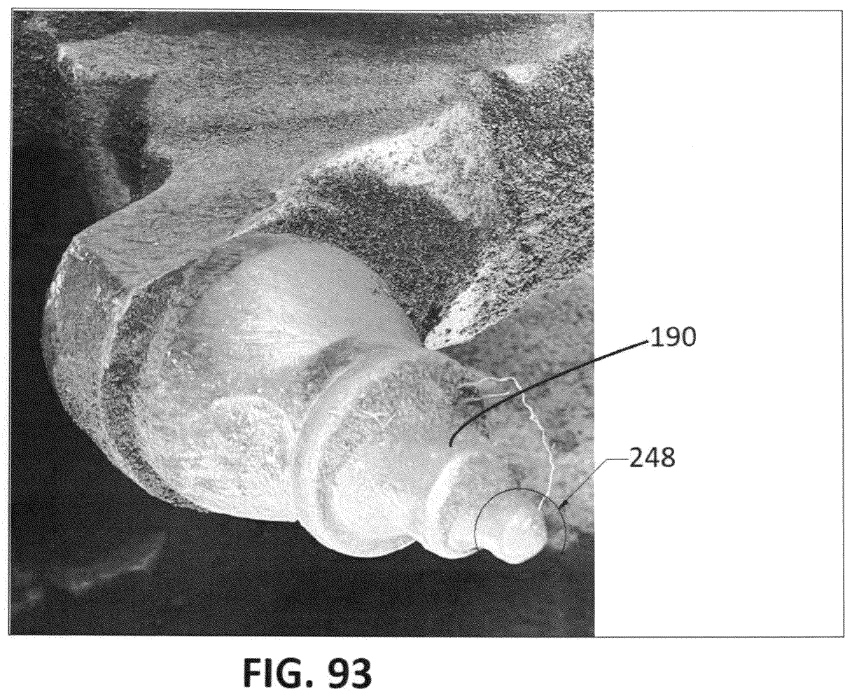

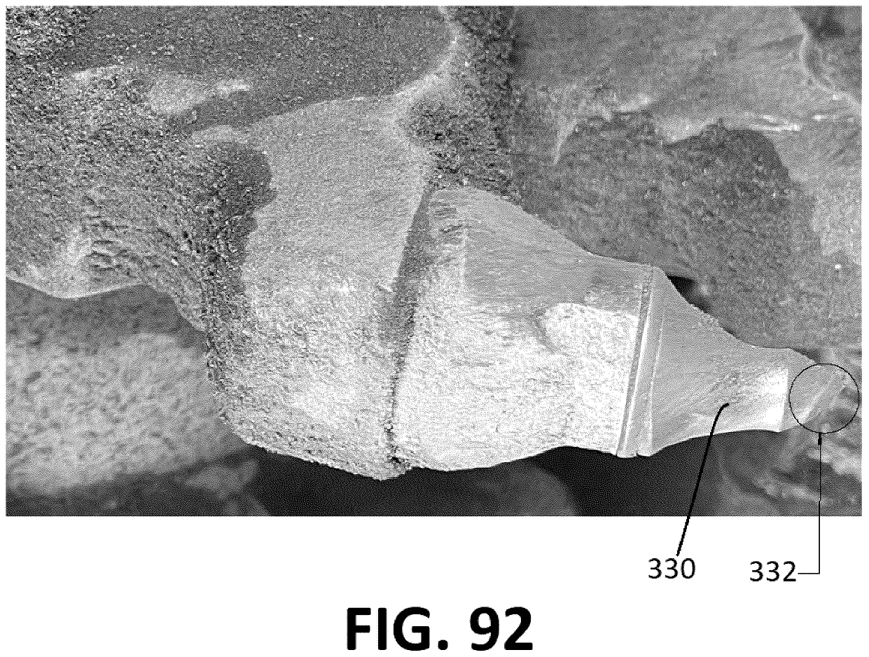

Referring to FIGS. 90-93, a worn bit 190, including retainer 10, 50, 110, 150, is shown on a drum adjacent a prior art worn bit 330 (FIGS. 90-92). It can be seen from FIGS. 92 and 93 that the prior art bit 330, having a non-rotating feature, shows substantial wear and a flat 332 (FIG. 92) that develops on the tip of the carbide bit tip, while the worn bit 190 of the present disclosure, having an excellent rotational feature, shows almost no wear 248 (FIG. 93) to the bit tip 232.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments and measurements, it is to be understood that the invention is not to be limited to the disclosed embodiments and measurements but, on the contrary, is intended to cover various modifications and equivalent arrangements included within the scope of the appended claims, which scope is to be accorded the broadest interpretation so as to encompass all such modifications and equivalent structures as is permitted under the law.

1. A retainer comprising:
a generally cylindrical hollow body portion including an axial forward end and an axial distal end;
a first slot extending through a sidewall of the body portion from the axial forward end to the axial distal end; and
at least one chamfer at the axial distal end of the retainer extending to an outer surface of the retainer, the at least one chamfer comprising a chamfer length and a chamfer height, the chamfer length being greater than the chamfer height.

2. The retainer of claim 1, further comprising:
a second slot axially extending from the axial distal end of the retainer through the sidewall of the retainer to a second slot termination, the second slot comprising a variable axial length and disposed approximately 180 degrees From the first slot, the second slot termination disposed a predetermined distance from the axial distal end of the retainer.

3. The retainer of claim 2, further comprising:
at least one third slot axially extending from the axial distal end of the retainer through the sidewall of the retainer to at least one third slot termination, the at least one third slot comprising a variable axial length and disposed circumferentially around the axial distal end of the retainer, the at least one third slot termination disposed a predetermined distance from the axial distal end of the retainer.

4. The retainer of claim 2, further comprising:
a plurality of third slots each axially extending from the axial distal end of the retainer through the sidewall of the retainer to a plurality of third slot terminations, the plurality of third slots each comprising a variable axial length and the plurality of third slot terminations each disposed a predetermined distance from the axial distal end of the retainer, at least two third slots disposed on either side of the first slot and the second slot.

5. The retainer of claim 1, further comprising:
at least one second slot axially extending from the axial distal end of the retainer through the sidewall of the retainer to at least one second slot termination, the at least one second slot comprising a variable axial length and disposed circumferentially around the axial distal end of the retainer, the at least one second slot termination disposed a predetermined distance from the axial distal end of the retainer.

6. The retainer of claim 1, the sidewall comprising at least one tab extending axially and radially inwardly, the at least one tab adapted to engage a flange on a shank of a bit to prevent the retainer from being removed from the shank.

7. The retainer of claim 6, wherein the at least one tab comprises two tabs disposed approximately 180 degrees From each other, each tab being approximately 90 degrees From the first slot.

8. The retainer of claim 6, further comprising:
at least one tab aperture defined by the at least one tab.

9. A bit comprising:
a body portion;
a generally cylindrical shank axially depending from a bottom of the body portion; and
a retainer disposed circumferentially about the shank, the retainer comprising:
a generally cylindrical hollow body portion including an axial forward end and an axial distal end;
a first slot extending through a sidewall of the body portion from the axial forward end to the axial distal end; and
at least one chamfer at the axial distal end of the retainer extending to an outer surface of the retainer, the at least one chamfer comprising a chamfer length and a chamfer height, the chamfer length being greater than the chamfer height.

10. The bit of claim 9, the retainer further comprising:
a second slot axially extending from the axial distal end of the retainer through the sidewall of the retainer to a second slot termination, the second slot comprising a variable axial length and disposed approximately 180 degrees From the first slot, the second slot termination disposed a predetermined distance from the axial distal end of the retainer.

11. The bit of claim 10, the retainer further comprising:
at least one third slot axially extending from the axial distal end of the retainer through the sidewall of the retainer to at least one third slot termination, the at least one third slot comprising a variable axial length and disposed circumferentially around the axial distal end of the retainer, the at least one third slot termination disposed a predetermined distance from the axial distal end of the retainer.

12. The bit of claim 10, the retainer further comprising:
a plurality of third slots each axially extending from the axial distal end of the retainer through the sidewall of the retainer to a plurality of third slot termination, the plurality of third slots each comprising a variable axial length and the plurality of third slot terminations each disposed a predetermined distance from the axial distal end of the retainer, at least two third slots disposed on either side of the first slot and the second slot.

13. The bit of claim 9, the retainer further comprising:
at least one second slot axially extending from the axial distal end of the retainer through the sidewall of the retainer to at least one second slot termination, the at least one second slot comprising a variable axial length and disposed circumferentially around the axial distal end of the retainer, the at least one second slot termination disposed a predetermined distance from the axial distal end of the retainer.

14. The bit of claim 9, the sidewall of the retainer comprising at least one tab extending axially and radially inwardly, the at least one tab adapted to engage a flange on a shank of a bit to prevent the retainer from being removed from the shank.

15. The bit of claim 14, the at least one tab comprising two tabs disposed approximately 180 degrees From each other, each tab being approximately 90 degrees From the first slot of the retainer.

16. The bit of claim 14, the retainer further comprising:
at least one tab aperture defined by the at least one tab.

17. The retainer of claim 1, further comprising:
a notch opposite the first slot of the retainer, the notch extending inwardly from the axial distal end of the retainer, the notch comprising a variable axial length.

18. The retainer of claim 17, further comprising:
a second slot extending from the notch through the sidewall of the retainer, the second slot comprising a variable axial length; and
a second slot termination of the second slot disposed a predetermined distance from the axial distal end of the retainer along an axial length of the retainer.

19. The retainer of claim 17, the notch being one of angular and arcuate.

20. The bit of claim 9, the retainer further comprising:
a notch opposite the first slot of the retainer, the notch extending inwardly from the axial distal end of the retainer, the notch comprising a variable axial length.

21. The bit of claim 20, the retainer further comprising:
a second slot extending from the notch through the sidewall of the retainer, the second slot comprising a variable axial length; and
a second slot termination of the second slot disposed a predetermined distance from the axial distal end of the retainer along an axial length of the retainer.

22. The bit of claim 20, the notch of the retainer being one of angular and arcuate.

23. The retainer of claim 2, the second slot positioned along a central portion of a solid back axial portion of the retainer opposite the first slot of the retainer, the back axial portion axially extending from the axial distal end of the retainer to the axial forward end of the retainer.

24. The bit of claim 10, the second slot of the retainer positioned along a central of a solid back axial portion of the retainer opposite the first slot of the retainer, the back axial portion axially extending from the axial distal end of the retainer to the axial forward end of the retainer.
